(19) United States
(12) Patent Application Publication
(10) Pub. No.: US 2012/0154609 A1
(43) Pub. Date: Jun. 21, 2012

(54) IMAGE RECORDING DEVICE, IMAGE RECORDING METHOD, AND PROGRAM

(75) Inventor: Koji Ozaki, Kanagawa (JP)

(73) Assignee: SONY CORPORATION, Tokyo (JP)

(21) Appl. No.: 13/310,935

(22) Filed: Dec. 5, 2011

(30) Foreign Application Priority Data
Dec. 15, 2010 (JP) P2010-279696

(51) Int. Cl. H04N 5/225

(52) U.S. Cl. 348/207.99; 348/E05.024

(57) ABSTRACT

An image recording device includes an image recording unit and a recording image instruction unit. The image recording unit includes a first time code adding unit, an image temporary storage unit, a savability information generation unit, a second time code adding unit, a first transmission unit, a determination unit, and a recording execution unit. The recording image instruction unit includes an image display unit, an operation unit, a monitoring unit, a response generation unit, and a second transmission unit.

### CROSS-REFERENCE TO RELATED APPLICATION

The present application claims priority from Japanese Patent Application No. JP 2010-279696 filed in the Japanese Patent Office on Dec. 15, 2010, the entire content of which is incorporated herein by reference.

### BACKGROUND

The present disclosure relates to an image recording device, an image recording method, and a program.

Image recording devices that record capturing image information of a subject that is obtained from an imaging element such as a CCD (Charge Coupled Device) imager or a CMOS (Complementary Metal Oxide Semiconductor) imager on a recording medium such as a magnetic tape, an optical disc, or a card type memory have been popularized as digital still cameras and digital video cameras.

As such a type of image recording device, an optical viewfinder may be used for the photographer to identify a subject to be captured. However, with a recent image recording device, generally, a monitor display image of the image information of the subject which is obtained from an imaging element is displayed on a display made of, for example, an LCD (Liquid Crystal Display). Furthermore, the photographer executes capturing of an image that is identified on the display by pressing a shutter button or pressing a recording start button after viewing and identifying the monitor display image that is displayed on the display.

However, for example, there may be a case where a delay occurs when displaying a monitor image of a subject from an imaging element on a display.

In a situation where such a delay occurs, when the photographer views the monitor capturing image of a monitor display unit and performs a recording instruction operation, there is a problem that there may be a case when the monitor capturing image and an image that is actually captured are different and the photographer is not able to record the intended image.

An imaging system in which the problem described above is resolved is disclosed in Japanese Unexamined Patent Application Publication No. 2006-325150. The imaging system according to Japanese Unexamined Patent Application Publication No. 2006-325150 has a configuration in which an imaging device and a monitor display device are separate and connected, for example, by wireless communication.

Further, the imaging device temporarily stores storage image data in a buffer memory by associating the storage image data with timing data that indicates the timing at which the storage image data was captured. Furthermore, the imaging device associates display image data with the same timing data as the storage image data and transmits the display image data to a monitor display device.

The monitor display device specifies the image that is displayed on the display device at a point in time when an imaging recording instruction is received from the user, and transmits the timing data that is associated with the image to the imaging device.

The imaging device that receives the timing data from the monitor display device reads the storage image data that relates to the timing data from the buffer memory and stores the storage image data in an image storage section.

According to the imaging system of Japanese Unexamined Patent Application Publication No. 2006-325150, since the image for which there is an instruction for imaging and recording is specified by the timing data that indicates the timing at which the image is captured, the problem of the delay between the imaging device and the monitor display device is resolved.

Japanese Unexamined Patent Application Publication No. 2008-306708 and Japanese Unexamined Patent Application Publication No. 09-307804 are examples of the related art.

### SUMMARY

In an imaging system of the related art that performs remote capturing as described above, for example, a time code at the imaging has been used as an identifier of an image or the same identifier for a recordable image and a display image has been used.

In the imaging system of the related art described above, no problem arises if a display image is captured at the same frame rate as that when an image is transferred or greater and at an integral multiple of the transmission frame rate. However, in a case when an image of a dark subject is captured or special effects are used at a slow shutter speed or in a case when the imaging frame rate is not an integral multiple of the transmission frame rate, the transmission frame rate may be made changeable. Furthermore, the image frame rate also varies from one imaging element to another depending not only on the shutter speed but also on the specifications of the imaging elements.

However, ordinarily, transmission of a plurality of images is performed using moving image compression or the like, and the transmission rate is not made to be changeable. Further, it is difficult to expect a function for making the transmission frame rate changeable to a recording image instruction unit that is not necessarily a separate imaging device. Furthermore, it is difficult to support various frame rates depending on the specification of the imaging element, and it is difficult to support an imaging frame rate after the fact.

Further, in a case when the transmission frame rate is to be fixed, since the same image frames are transferred over a plurality of times and the same time codes are naturally also transferred over a plurality of times, there is a problem that it becomes difficult to accurately ascertain the image recording timing by the user and it becomes difficult to record a capturing image that is intended by the user. Furthermore, since the frame rate of the display image is different from that of the recordable image, it is difficult to determine whether or not an image is able to be recorded at the time the user instructs recording.

It is desirable to provide an image recording device, an image recording method, and a program that are able to record a capturing image that is intended by the user while maintaining a fixed transmission frame rate.

According to an embodiment of the disclosure, there is provided an image recording device including: an image recording unit and a recording image instruction unit. The image recording unit includes a first time code adding unit that adds a time code to each frame of a display image that is input at a first frame rate, an image temporary storage unit that associates a plurality of frames of a recordable image which are input at a second frame rate with a time code and temporarily stores the plurality of frames in an unused region or an erasable region, a savability information generation unit that generates savability information of the recordable image in the image temporary storage unit, a second time code adding unit that adds a time code that is associated with the recordable image to the savability information, a first transmission unit that transmits the display image, to which a time code is added, to the recording image instruction unit at the first frame rate and transmits the savability information to the recording image instruction unit, a determination unit that determines whether or not a response with a time code from the recording image instruction unit is an image recording instruction, and a recording execution unit that obtains an image of a frame, which is specified based on the time code that is included in the response, from the image temporary storage unit when it is determined by the determination unit that the response is the image recording instruction and that records the image in a recording medium. The recording image instruction unit includes an image display unit that displays on a display the display image from the image recording unit to which the time code has been added, an operation unit that receives an operation input, a monitoring unit that monitors an operation input through the operation unit regarding the display image that is displayed on the display, a response generation unit that generates as the response an image recording instruction that includes the time code that has been associated with the recordable image from the image recording unit based on each time code of the display image when it is determined by the monitoring unit that an operation through the operation unit is performed, and a second transmission unit that transmits the response that is generated by the response generation unit to the image recording unit.

The response generation unit may generate as the response an erasable instruction that includes the time code that has been associated with the recordable image based on each time code of the display image when it is determined that there is no operation through the operation unit by the user, and the image recording unit may include an erasing processing unit that makes a storage region of the image temporary storage unit for an image of a frame that is specified by a time code that is included in the response erasable, when it is determined by the determination unit that the response is not the image recording instruction.

The recording image instruction unit may include a savability display unit that displays savability based on the savability information from the image recording unit in a state of the savability being associated with the display image.

The savability information generation unit may generate as the savability information the number of image savable frames in the image temporary storage unit.

The recording image instruction unit may include a determination unit that determines whether or not an image of a frame that is specified by the operation input has been stored in the image temporary storage unit of the image recording unit based on the savability information from the image recording unit when there is an operation input by the user through the operation unit, and a warning unit that causes at least one of a warning display and a warning sound to be made in response to the operation input when it is determined by the determination unit that an image of a frame that is specified by the operation input has not been stored in the image temporary storage unit of the image recording unit.

The image recording unit may include a frame rate setting unit that sets the second frame rate of the recordable image in response to an instruction by the user to change the second frame rate.

The recording image instruction unit may include a receiving unit that receives a deletion instruction relating to an image for which there is an instruction for image recording through the operation unit, and a third transmission unit that adds a time code of the image, for which there is an instruction for deletion, to the deletion instruction that is received by the receiving unit and transmits the deletion instruction to the image recording unit, and the image recording unit may include an image deletion unit that receives the deletion instruction from the recording image instruction unit and deletes an image that is specified by the time code that is included in the deletion instruction from images in the image temporary storage unit, the recording medium, or that is being recorded.

The image recording unit and the recording image instruction unit may be separate from each other.

Two or more recording image instruction units may be connectable to one image recording unit.

The image recording unit may include a first frame interpolation unit that performs frame interpolation with respect to a display image that is input at a third frame rate and supplies the display image to the first time code adding unit at the first frame rate.

The recording image instruction unit may include a second frame interpolation unit that performs frame interpolation with respect to the display image that is received from the image recording unit at the first frame rate and supplies the display image to the image display unit at a fourth frame rate, and the second frame interpolation unit may also perform interpolation with respect to a time code of the display image that is received at the first frame rate.

The image recording unit may include a first buffer unit that performs buffering of a display image that is input at a fifth frame rate and supplies the display image to the first time code adding unit at the first frame rate.

The recording image instruction unit may include a second buffer unit that performs buffering of the display image that is received from the image recording unit at the first frame rate and supplies the display image to the image display unit at a sixth frame rate.

The image recording unit may include a first orientation information generation unit that generates orientation information of the image recording unit, and the first time code adding unit may further add orientation information that is generated by the first orientation information generation unit for each frame of a display image that is input at the first frame rate, the first transmission unit may transmit the display image to which orientation information that is generated by the first orientation information generation unit is further added, to the recording image instruction unit. The recording image instruction unit may include a second orientation information generation unit that generates orientation information of the recording image instruction unit, and the image display unit may display the display image from the image recording unit, to which the orientation information that is generated by the first orientation information generation unit is further added, on the display based on the orientation information that is generated by the first orientation information generation unit and based on the orientation information generated by the second orientation information generation unit.

The image temporary storage unit may further associate a plurality of frames of the recordable image with orientation information that is generated by the first orientation information generation unit and temporarily store the frames associated with the orientation information.

The recording execution unit may further obtain orientation information that is generated by the first orientation information generation unit from the image temporary storage unit, associate an image with the orientation information that is generated by the first orientation information generation unit, and record the image associated with the orientation information on the recording medium.

According to another embodiment of the disclosure, there is provided an image recording method including: causing an image recording unit to add a time code to each frame of a display image that is input at a first frame rate, associate a plurality of frames of a recordable image which are input at a second frame rate with a time code and store the plurality of frames to be stored in an image temporary storage unit that temporarily stores the frames in an unused region or an erasable region, generate savability information of the recordable image in the image temporary storage unit, add a time code that is associated with the recordable image to the savability information, transmit the display image, to which the time code is added, to a recording image instruction unit at the first frame rate and transmit the savability information to the recording image instruction unit, determine whether a response with a time code from the recording image instruction unit is an image recording instruction, and obtain an image of a frame that is specified based on a time code that is included in the response from the image temporary storage unit when it is determined by the determination unit that the response is the image recording instruction and record the image in a recording medium; and causing a recording image instruction unit to display on a display an image from the image recording unit to which the time code is added, monitor an operation input through the operation unit regarding the display image that is displayed on the display, generate an image recording instruction that includes a time code that is associated with the recordable image from the image recording unit based on each time code of the display image as the response when it is determined that an operation through the operation unit is performed by the monitoring, and transmit the response that is generated by the response generation unit to the image recording unit.

According to still another embodiment of the disclosure, there is provided a program to cause a computer to function as: an image recording unit that includes a first time code adding unit that adds a time code to each frame of a display image that is input at a first frame rate, an image temporary storage unit that associates a plurality of frames of a recordable image which are input at a second frame rate with a time code and temporarily stores the plurality of images in an unused region or an erasable region, a savability information generation unit that generates savability information of the recordable image in the image temporary storage unit, a second time code adding unit that adds a time code that is associated with the recordable image to the savability information, a first transmission unit that transmits the display image, to which a time code is added, to a recording image instruction unit at the first frame rate and transmits the savability information to the recording image instruction unit, a determination unit that determines whether or not a response with a time code from the recording image instruction unit is an image recording instruction, and a recording execution unit that obtains an image of a frame, which is specified based on the time code that is included in the response, from the image temporary storage unit when it is determined by the determination unit that the response is the image recording instruction and that records the image in a recording medium; and function as a recording image instruction unit that includes an image display unit that displays on a display the display image from the image recording unit to which the time code is added, an operation unit that receives an operation input, a monitoring unit that monitors an operation input through the operation unit regarding the display image that is displayed on the display, a response generation unit that generates as the response an image recording instruction that includes the time code that is associated with the recordable image from the image recording unit based on each time code of the display image when it is determined by the monitoring unit that an operation through the operation unit is performed, and a second transmission unit that transmits the response that is generated by the response generation unit to the image recording unit.

As described above, according to embodiments of the disclosure, it is possible to record a capturing image that the user intends while maintaining a fixed transmission frame rate.

### BRIEF DESCRIPTION OF THE DRAWINGS

FIG. 1 is a diagram that illustrates a system configuration example of an image recording device of a first embodiment;

FIG. 2 is a block diagram that illustrates a hardware configuration example of a capturing image recording device of FIG. 1;

FIG. 3 is a block diagram describing a more detailed configuration example of a portion of the capturing image recording device of FIG. 1;

FIG. 4 is a diagram describing a configuration example of FIG. 3;

FIG. 5 is a block diagram that illustrates a hardware configuration example of the recording image instruction device of FIG. 1;

FIG. 6 is a flowchart of an exemplary transmission processing operation of a capturing image recording device of the image recording device of the first embodiment;

FIG. 7 is a flowchart of an exemplary receiving processing operation of a capturing image recording device of the image recording device of the first embodiment;

FIG. 8 is a flowchart of a portion of an exemplary processing operation of a recording image instruction device of the image recording device of the first embodiment;

FIG. 9 is a flowchart of a portion of an exemplary processing operation of the recording image instruction device of the image recording device of the first embodiment;

FIG. 10 is a diagram describing a capture recording processing operation in the image recording device of the first embodiment;

FIG. 11 is a block diagram describing a more detailed configuration example of a portion of a capturing image recording device of an image recording device of a second embodiment;

FIGS. 12A and 12B are diagrams describing a capture recording processing operation in the image recording device of the second embodiment;

FIG. 13 is a flowchart of an exemplary transmission processing operation in a capturing image recording device of the image recording device of the second embodiment;

FIG. 14 is a diagram describing a capture recording processing operation in the image recording device of the second embodiment;

FIG. 15 is a diagram describing a capture recording processing operation in the image recording device of the second embodiment;

FIG. 16 is a block diagram that illustrates a hardware configuration example of a recording image instruction device of the image recording device of the second embodiment;

FIG. 17 is a flowchart of a portion of an exemplary processing operation in a recording image instruction device of the image recording device of the second embodiment;

FIG. 18 is a block diagram describing a more detailed configuration example of a portion of a capturing image recording device of an image recording device of a third embodiment;

FIG. 19 is a block diagram that illustrates a hardware configuration example of a recording image instruction device of the image recording device of the third embodiment;

FIG. 20 is a flowchart of an exemplary processing operation in a capturing image recording device of the image recording device;

FIG. 21 is a diagram that illustrates a system configuration example of a fourth embodiment of the image recording device;

FIGS. 22A and 22B are diagrams describing a fifth embodiment;

FIGS. 23A to 23C are diagrams describing the fifth embodiment;

FIGS. 24A and 24B are diagrams describing the fifth embodiment;

FIG. 25 is a diagram that illustrates a system configuration example of a seventh embodiment of the image recording device;

FIG. 26 is a block diagram describing a more detailed configuration example of a portion of the capturing image recording device of FIG. 25;

FIG. 27 is a diagram describing a configuration example of FIG. 26; and

FIG. 28 is a block diagram that illustrates a hardware configuration example of the recording image instruction device of FIG. 25.

### DETAILED DESCRIPTION OF EMBODIMENTS

Preferable embodiments of the disclosure will be described in detail below with reference to the attached drawings. Here, in the present specification and drawings, with regard to configuration elements with basically the same functional configurations, duplicate description is omitted by using the same symbols.

Here, description will be given in the following order.
1. Image Recording Device (First Embodiment)
2. Configuration Example of Capturing Image Recording Device
3. Configuration Example of Display Image Generation Unit and Instructed Image Recording Unit
4. Configuration Example of Recording Image Instruction Device
5. Generation and Transmission of Response from Image Recording Instruction or Image Erasing Instruction
6. Flowchart of Processing Operation of Capturing Image Recording Device (First Embodiment)
7. Flowchart of Processing Operation of Recording Image Instruction Device (First Embodiment)
8. Configuration Example of Capturing Image Recording Device in Image Recording Device (Second Embodiment)
9. Flowchart of Processing Operation of Capturing Image Recording Device (Second Embodiment)
10. Configuration Example of Recording Image Instruction Device in Image Recording Device (Second Embodiment)
11. Flowchart of Processing Operation of Recording Image Instruction Device (Second Embodiment)
12. Configuration Example of Capturing Image Recording Device in Image Recording Device (Third Embodiment)
13. Configuration Example of Recording Image Instruction Device in Image Recording Device (Third Embodiment)
14. Processing Operations Based on Explicit Image Deletion Instruction by User
15. Image Recording Device (Fourth Embodiment)
16. Image Recording Device (Fifth Embodiment)
17. Image Recording Device (Sixth Embodiment)
18. Image Recording Device (Seventh Embodiment)
19. Configuration Example of Display Image Generation Unit and Instructed Image Recording Unit (Seventh Embodiment)
20. Configuration Example of Recording Image Instruction Device (Seventh Embodiment)
21. Other Embodiments and Modified Examples

### 1. Image Recording Device (First Embodiment)

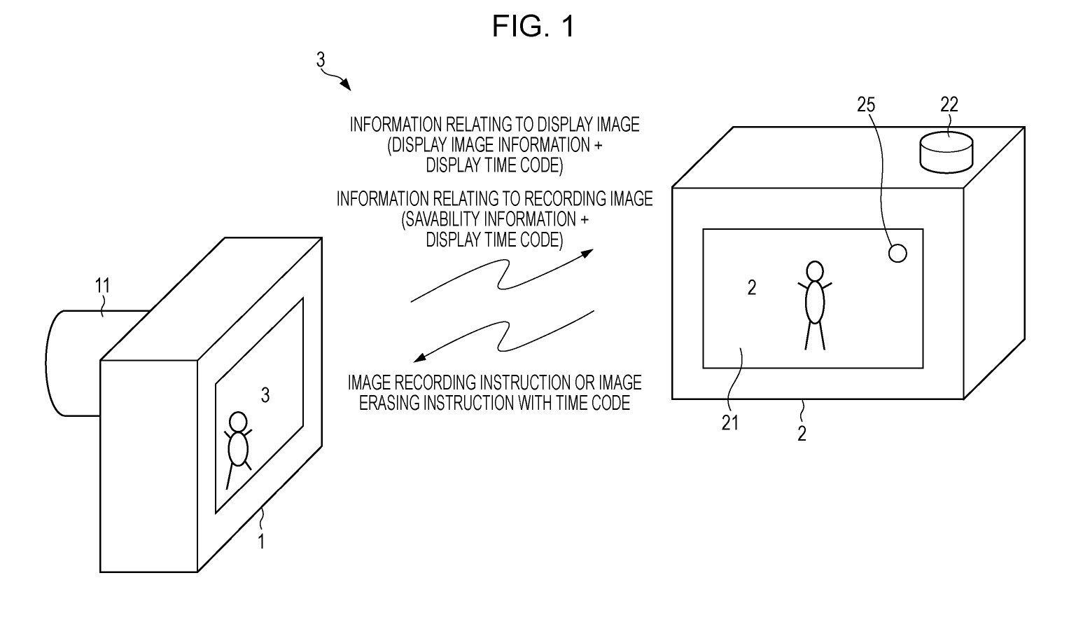

First, an image recording device according to the first embodiment of the disclosure will be described. FIG. 1 is a system configuration diagram of an image recording device of the embodiment that is applied in a case when recording a capturing image of a still image. As illustrated in FIG. 1, the image recording device of the embodiment has a configuration of being composed of a capturing image recording device 1 and a recording image instruction device 2 and in which the capturing image recording device 1 and the recording image instruction device 2 are connected by a wireless communication path 3. In the embodiment, a delay is caused by the data transmission through the wireless communication path 3. The capturing image recording device 1 corresponds to an image recording unit of the embodiments and the recording image instruction device 2 corresponds to the recording image instruction unit of the embodiments.

Although the wireless communication path 3 uses radio waves in the example, the wireless communication path 3 may also use light, ultrasonic waves, or the like.

The capturing image recording device 1 does not include a shutter button but includes a function of recording capturing images, a function of generating information relating to a display image or information relating to a recording image of a subject to be capturing recorded, and a function of transmitting information relating to the generated display image or information related to the recording image to the recording image instruction device 2 through the wireless communication path 3. Further, the capturing image recording device 1 includes a function of receiving a response including a recording image instruction from the recording image instruction device 2 through the wireless communication path 3 and performing control such that recording of the capturing image for which there is an instruction for recording is executed. Alternatively, the capturing image recording device 1 may include a shutter button (not shown) and may include a function of monitoring the operation of the shutter button by the user (photographer) and a function of recording the capturing image based on the monitoring result.

The recording image instruction device 2 receives information relating to the display image from the capturing image recording device 1 through the wireless communication path 3 and includes a function of displaying the capturing image on a display 21, for example, composed of an LCD and a function of transmitting a response with respect to the received information relating to the recording image to the capturing image recording device 1 through the wireless communication path 3.

Further, the recording image instruction device 2 includes a function of monitoring the operation of a shutter button 22 by the user (photographer) and a function of generating the response based on the monitoring result. In the function of generating the response, a recording image instruction is generated when it is determined that the shutter button 22 is operated by the user.

Furthermore, when it is determined that the shutter button 22 is not operated by the user, in the function of generating the response, an erasable instruction is generated. The erasable instruction is transmitted with respect to recording image signals to which a recording instruction was not given by the user out of the recording image signals that are stored in the image temporary storage unit of the capturing image recording device 1. The capturing image recording device 1 erases the recording image signals that are specified by a time code TC that is included in the erasable instruction from the image temporary storage unit.

Alternatively, without erasing the recording image signals, the storage region of the image temporary storage unit where the recording image signals that are specified by the time code TC are stored becomes an erasable region. In the image temporary storage unit, the erasable region are able to be overwritten with subsequent recording image signals.

In the description below, the recording image signals are not erased in the image temporary storage unit, and the storage regions of erasable recording image signals become erasable regions.

### 2. Configuration Example of Capturing Image Recording Device

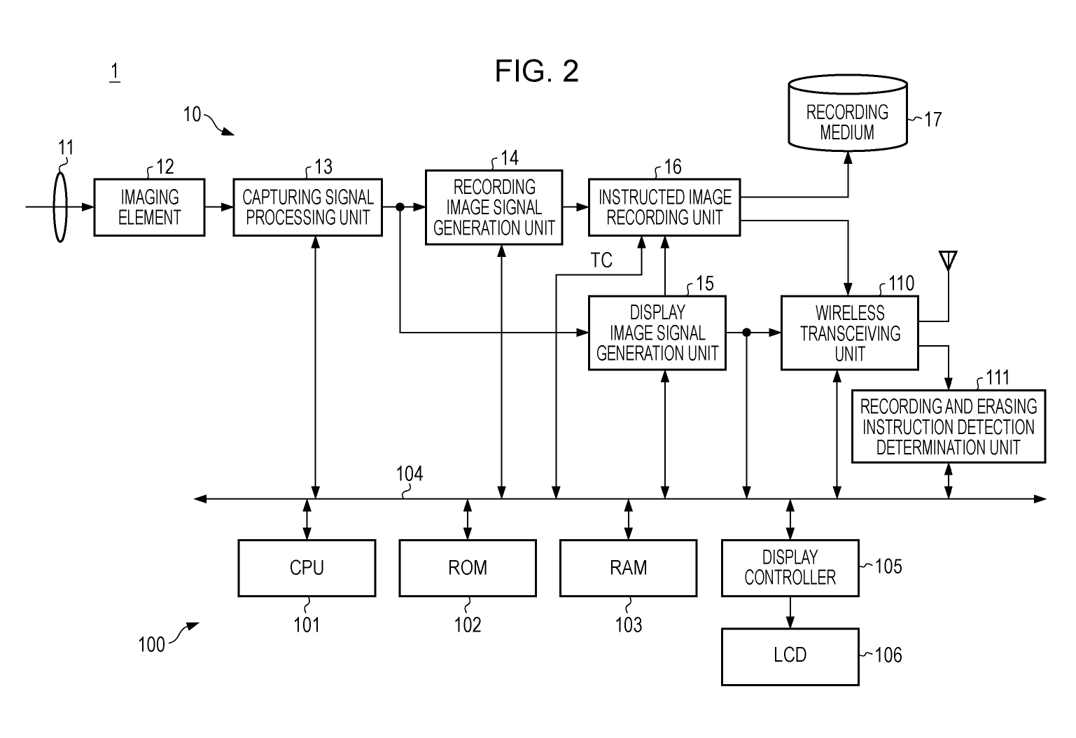

FIG. 2 is a block diagram of a configuration example of the capturing image recording device 1. The capturing image recording device 1 of the example is configured to include a capturing recording unit 10, a control unit 100, a wireless transceiving unit 110, and a recording and erasing instruction detection determination unit 111. The wireless transceiving unit 110 is one example of a first transmission unit of an embodiment of the disclosure.

The control unit 100 includes a microcomputer. That is, the control unit 100 includes a CPU (Central Processing Unit) 101, a ROM (Read Only Memory) 102, and a RAM (Random Access Memory) 103, which are connected to a system bus 104.

Further, a display element 106 composed of an LCD, for example, is connected to the system bus 104 via a display controller 105. Here, the display controller 105 and the display element 106 may be omitted.

As illustrated in FIG. 2, the capturing recording unit 10 includes a capturing lens 11 and a capturing element 12. The capturing element 12 includes a CMOS imager in the example. Capturing image signals at a predetermined capturing frame rate of, for example, 60 fps (frames per second), is output from the capturing element 12.

The capturing image signals from the capturing element 12 are supplied to a capturing signal processing unit 13. The capturing signal processing unit 13 performs corrections such as a γ correction on the capturing signals, converts, for example, brightness signals Y and color difference signals Cr and CB of raw data, and outputs the signals as digital capturing data.

The digital capturing data output from the capturing signal processing unit 13 is supplied to a recording image signal generation unit 14 and a display image signal generation unit 15.

The recording signal generation unit 14 generates, from the digital capturing data received from the capturing signal processing unit 13, recording image signals of frame units of a resolution that is specified by a control signal from the control unit 100 and supplies the generated recording image signals of frame units to an instructed image recording unit 16.

The instructed image recording unit 16 includes an image temporary storage unit, and adds a time code (recording time code) to a recording image signal (recordable image) of each frame and temporarily stores recording image signals for a plurality of frames at any given time. The recording time code is time information of the corresponding frame. The instructed image recording unit 16 is one example of a recording execution unit of an embodiment of the disclosure.

Here, the number of frames (storage capacity of the image temporary storage unit) of the recording image signals that are temporarily storable in the image temporary storage unit at least includes the delay amount (reciprocating amount) over the wireless communication path 3. Further, the storage capacity of the image temporary storage unit includes the excess amount.

In such an example, for convenience of description, it is supposed that the delay over the wireless communication path 3 is equivalent to one frame for one way, and that the storage capacity of the image temporary storage unit (number of frames of storable images) is, for example, equivalent to four frames.

Savability information that indicates whether or not the instructed image recording unit 16 is able to save recording image signals in the image temporary storage unit is generated when writing or after writing a recording image signal of one frame. In the embodiment, the savability information is the number of frames (number of savable frames) that are able to be written into the unrecorded region and the erasable region of the image temporary storage unit.

Furthermore, the instructed image recording unit 16 adds the same recording time code as the recording time code that is added to the recording image signal of the next frame to the generated savability information and transmits the savability information to the recording image instruction device 2 through the wireless transceiving unit 110. The information relating to the recording image corresponds to the savability information to which a recording time code is added which is output from the instructed image recording unit 16.

Further, as will be described later, a recording image instruction that designates using the time code TC an image to be recorded is supplied from the control unit 100 to the instructed image recording unit 16. The instructed image recording unit 16 recognizes by the time code TC the recording image signal of a frame that is designated by the recording image instruction and extracts the recording image signal from the recording image signals of four frames that are being temporarily stored. Furthermore, the instructed image recording unit 16 writes and records the extracted recording image signal in a recording medium 17 such as, for example, a card type memory.

Further, the display image signal generating unit 15 generates, from the digital capturing data received from the capturing signal processing unit 13, display image signals of frame units of a display resolution that is designated by a control signal from the control unit 100. Furthermore, the display image signal generation unit 15 adds a time code (display time code) to the generated display image signals of frame units and transmits the display image signals to the recording image instruction device 2 through the wireless transceiving unit 110. Display image signals at a predetermined transmission frame rate are output from the display image signal generation unit 15. The information relating to the display image corresponds to the display image signals, to which display time codes are added, to be output from the display image signal generation unit 15.

Here, in the example of FIG. 2, the display image from the display image signal generation unit 15 is transmitted to an LCD 106 through the display controller 105 under the control of the control unit 100, and is also displayed on the LCD 106. In a case when the capturing image recording device 1 is held by the user and pointed toward a subject, the user is able to verify the subject to be captured by viewing the display image on the LCD 106.

In the recording image instruction device 2, once information relating to the display image is received from the capturing image recording device 1, while the information is retained with the display time code of each frame separated, the monitor display image by the display image signal of each frame is displayed on the display 21 based on the display time code. Further, in the recording image instruction device 2, once the information relating to the recording image is received from the capturing image recording device 1, the information is retained with the savability information and the recording time code separated. At this time, a savability display 25 is displayed based on the savability information and the recording time code on the display 21 by being superimposed over the monitor display image.

The savability display 25 may use, for example, a savability mark as illustrated in FIG. 1, or in a case when the savability information is the number of savable frames as in the example, the savability display 25 may be a numerical display that represents the number of savable frames. As the savable mark of the example of FIG. 1, for example, a “◯” mark is displayed if the number of savable frames is 1 or more and saving is possible, and a “x” mark is displayed if the number of savable frames is 0 and saving is difficult.

The user of the recording image instruction device 2 presses down on the shutter button 22 for the display image to be recorded, having verified the savability of a recordable image in the image temporary storage unit of the capturing image recording device 1 on the savability display 25 while observing the monitor display image of the display 21.

The recording image instruction device 2 monitors the operation of the shutter button 22 by the user with respect to the display image that is displayed on the display 21.

Furthermore, when the recording image instruction device 2 determines that there is no operation of the shutter button 22 with respect to the display image, the recording image instruction device 2 transmits to the capturing image recording device 1 an image erasing instruction of a recordable image that corresponds to the timing as a response to the information relating to the recording image. In such a case, the recording time code of the recordable image that is the erasing target is included in the image erasing instruction.

Further, when there is an operation on the shutter button 22 by the user with respect to the display image that is displayed on the display 21, the recording image instruction device 2 transmits to the capturing image recording device 1 the image recording instruction of the recordable image that corresponds to the timing as a response to the information relating to the recording image. The recording time code of the recordable image that is the recording target is included in the image recording instruction.

As described above, in the embodiment, the recording image instruction device 2 returns a response to the capturing image recording device 1 with respect to the information relating to the recording image that is received from the capturing image recording device 1. Furthermore, the recording image instruction device 2 respectively sends an image erasing instruction and an image recording instruction to the capturing image recording device 1 as the response when the user does not operate the shutter button 22 and when the user operates the shutter button 22.

In the capturing image recording device 1, the response from the recording image instruction device 2 is received by the wireless transmission unit 110 and sent to the recording and erasing instruction detection determination unit 111. The recording and erasing instruction detection determination unit 111 determines whether the received response is an image erasing instruction or an image recording instruction, and transmits the determination result along with the recording time code that is included in the response to the control unit 100 through the system bus 104.

The control unit 100 sends, when the determination result is an image erasing instruction, an instruction to erase the recordable image of the recording time code that is received along with the determination result from the image temporary storage unit of the instructed image recording unit 16 to the instructed image recording unit 16. The instructed image recording unit 16 that receives such an instruction makes the storage region of the image temporary storage unit in which the recordable image of the instructed recording time code was recorded an erasable region.

Further, the control unit 100 sends, when the determination result is an image recording instruction, an instruction to record the recordable image of the recording time code that is received along with the determination result in the recording medium 17 to the instructed image recording unit 16. The instructed image recording unit 16 that receives such an instruction reads the recordable image of the instructed recording time code from the image temporary storage unit and records the recordable image in the recording medium 17. Furthermore, after the end of recording, the instructed image recording unit 16 makes the storage region of the image temporary storage unit, in which the recordable image of the instructed recording time code was recorded, an erasable region.

As above, the instructed image recording unit 16 recognizes, by the recording time code that is included in the recording image instruction, the image frame that is instructed by the user in the recording image instruction device 2 to be the image frame to be recorded, and records the recording image signal of the image frame that is specified by the recording time code in the recording medium 17. Furthermore, the instructed image recording unit 16 secures a storage region in which new image frames are stored by making the image frame that is recorded and other image frames for which there were no instructions for recording erasable from the image temporary storage unit.

### 3. Configuration Example of Display Image Generation Unit and Instructed Image Recording Unit

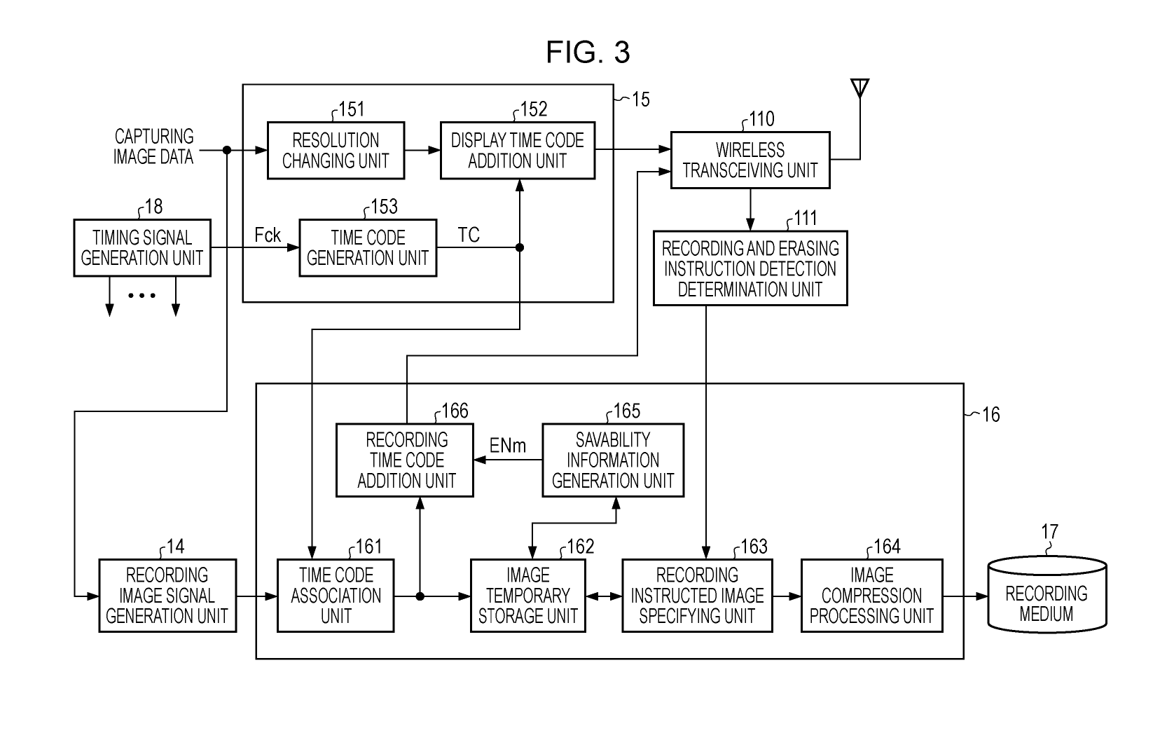

Next, with regard to FIG. 3, detailed configuration examples of the display image signal generation unit 15 and the instructed image recording unit 16 in the capturing image recording device 1 will be described. FIG. 3 illustrates the functional blocks of the display image signal generation unit 15 and the instructed image recording unit 16 in the capturing image recording device 1.

As illustrated in FIG. 3, the display image signal generation unit 15 includes a resolution changing unit 151, a display time code adding unit 152, and a time code generation unit 153. The resolution changing unit 151 generates from the capturing image data received from the capturing signal generation unit 13 display image data with a resolution that is based on control information of the display resolution from the control unit 100, and supplies the generated display image data to the display time code adding unit 152 at the transmission frame rate. The transmission frame rate is one example of a first frame rate according to an embodiment of the disclosure.

Although not shown in FIG. 2, as illustrated in FIG. 3, the capturing image recording device 1 includes a timing signal generation unit 18 that generates various types of timing signals such as those for the pixel rate or the frame rate. Capturing image signals are read from the imaging element 12 based on the timing signals from the timing signal generation unit 18.

Furthermore, as illustrated in FIG. 3, a clock signal Fck from the timing signal generation unit 18 is supplied to the time code generation unit 153 of the display image signal generation unit 15. The time code generation unit 153 generates the time code TC based on the clock signal Fck. Furthermore, the time code generation unit 153 supplies the generated time code TC to the display time code adding unit 152.

In the display time code adding unit 152, the time code TC (display time code) is added to each frame unit of the display image data from the resolution changing unit 151. Furthermore, in the time code adding unit 152, the display image data to which the display time code is added is wirelessly transmitted to the recording image instruction device 2 through the wireless transceiving unit 110. The information relating to the display image corresponds to the display image data to which the display code is added which is output from the display image signal generation unit 15. The display time code adding unit 152 is one example of the first time code adding unit.

The instructed image recording unit 16 is configured to include a time code association unit 161, an image temporary storage unit 162, a recording instructed image specifying unit 163, an image compression processing unit 164, a savability information generation unit 165, and a recording time code adding unit 166. Recording image signals are supplied to the instructed image recording unit 16 at the capturing frame rate. The capturing frame rate is one example of a second frame rate of an embodiment of the disclosure.

As well as the recording image signals being supplied from the recording image signal generation unit 14, the time code TC from the time code generation unit 153 of the display image signal generation unit 15 is supplied to the time code association unit 161.

The time code association unit 161 adds the time code TC (recording time code) to each frame unit of the recording image signals (respective recordable images) from the recording image signal generation unit 14 and supplies the recording image signals to the image temporary storage unit 162. Further, the time code association unit 161 supplies the recording time codes that are added to the recording image signals to the recording time code adding unit 166.

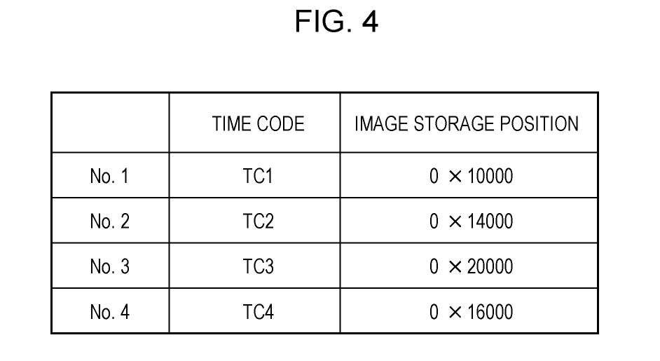

The image temporary storage unit 162 is configured, as described above, in the example, to be able to store recording image signals of four frames along with the recording time codes thereof. The storage content of the image temporary storage unit 162 will be described with reference to FIG. 4.

That is, the image temporary storage unit 162 includes four frame storage regions of No. 1 to No. 4, and is able to store four frames of recording image signals in a state of being associated with recording time codes in the four frame storage regions.

Furthermore, the recording image signal of the first frame is first recorded in the No. 1 frame storage region of the image temporary storage unit 162. When the recording image signal of the second frame arrives, the recording image signal of the second frame is stored in the No. 2 frame storage region that is an unrecorded region (free space). Further, when the recording image signal of the third frame arrives, the recording image signal of the third frame is newly stored in the No. 3 frame storage region that is an unrecorded region (free space). Thereafter, new recording image signals are successively stored in unrecorded regions.

Furthermore, if unrecorded regions are exhausted in the image temporary storage unit 162, as will be described later, new recording image signals are stored in storage regions that are erasable regions.

Therefore, it is possible to temporarily retain recording image signals of four frames in the image temporary storage unit 162. Furthermore, the recording image signals of the frames that are able to be temporarily stored in the image temporary storage unit 162 become recordable images.

Furthermore, as described below, the recording instructed image specifying unit 163 receives a determination of result from the recording and erasing instruction detection determination unit 111 of whether the response is an image recording instruction or an image erasing instruction, and performs recording or erasing processing of images that are temporarily stored in the image temporary storage unit 162.

First, if the recording instructed image specifying unit 163 receives a determination result from the recording and erasing instruction detection determination unit 111 that the response is an image recording instruction, the recording instructed image specifying unit 163 specifies, using the recording time code that is sent at the same time, the image of the frame for which there is an instruction for image recording. That is, the recording instructed image specifying unit 163 specifies the frame of the recording image signal that includes the same recording time code as the recording time code that is received from the recording and erasing instruction detection determination unit 111 as the recording image signal of the frame to be recorded. Here, the recording instructed image specifying unit 163 may specify the frame of the recording image signal that includes a recording time code different from the recording time code that is received from the recording and erasing instruction detection determination unit 111 as the recording image signal of the frame to be recorded. For example, a deviation amount may be set in the capturing image recording device 1 in advance, and with the recording time code that is received from the recording and erasing instruction detection determination unit 111 as the reference, the recording instructed image specifying unit 163 may specify the frame of the recording image signal that includes a recording time code that is deviated by the set deviation amount as the recording image signal of the frame to be recorded. Further, by setting a deviation amount in the recording image instruction device 2 in advance and by causing the recording image instruction device 2 to transmit an image recording instruction with the deviation amount added, for example, the recording instructed image specifying unit 163 may specify, with the recording time code that is received from the recording and erasing instruction detection determination unit 111 as the reference, the frame of the recording image signal that includes a recording time code that is deviated by the set deviation amount as the recording image signal of the frame to be recorded.

Furthermore, the recording instructed image specifying unit 163 searches for and reads the frame of the specified recording image signal from among the recording image signals that are stored in the image temporary storage unit 162 based on the recording time code and supplies the frame to the image compression processing unit 164.

The image compression processing unit 164 compression processes a recording image signal by an appropriate still image compression processing method such as, for example, a JPEG (Joint Photographic Experts Group) method and recorded the compressed image signal in the recording medium 17.

Once the recording of the image in the recording medium 17 is ended, the recording instructed image specifying unit 163 makes the storage region of the image temporary storage unit 162 in which the recording image signal in which the recording has ended was stored an erasable region.

Further, if the recording instructed image specifying unit 163 receives a determination result from the recording and erasing instruction detection determination unit 111 that the response is an image erasing instruction, the recording instructed image specifying unit 163 specifies the image of the frame for which there is an instruction for image erasing by the recording time code that is sent at the same time. That is, the recording instructed image specifying unit 163 specifies the frame of the recording image signal that includes the same recording time code as the recording time code that is received from the recording and erasing instruction detection determination unit 111 as the recording image signal of the frame to be erased. Here, the recording instructed image specifying unit 163 may specify the frame of the recording image signal that includes a different recording time code to the recording time code that is received from the recording and erasing instruction detection determination unit 111 as the recording image signal of the frame to be erasable. For example, a deviation amount may be set in the capturing image recording device 1 in advance, and with the recording time code that is received from the recording and erasing instruction detection determination unit 111 as the reference, the recording instructed image specifying unit 163 may specify the frame of the recording image signal that includes a recording time code that is deviated by the set deviation amount as the recording image signal of the frame to be erasable. Further, by setting a deviation amount in the recording image instruction device 2 in advance and by causing the recording image instruction device 2 to transmit an image recording instruction with the deviation amount added, for example, the recording instructed image specifying unit 163 may specify, with the recording time code that is received from the recording and erasing instruction detection determination unit 111 as the reference, the frame of the recording image signal that includes a recording time code that is deviated by the set deviation amount as the recording image signal of the frame to be erasable.

Furthermore, the recording instructed image specifying unit 163 makes the storage region of the image temporary storage unit 162 in which the specified recording image signal was stored an erasable region.

The image temporary storage unit 162 is able to overwrite and store recording image signals that newly arrive from the recording image signal generation unit 14 in erasable regions.

The savability information generation unit 165 detects, by monitoring the unrecorded regions and the erasable regions of the image temporary storage unit 162, how many frames are then storable in the image temporary storage unit 162, that is, the number of savable frames. Furthermore, the savability information generation unit 165 supplies the number of savable frames that are detected as savability information ENm to the recording time code adding unit 166.

In the recording time code adding unit 166, the recording time code from the time code association unit 161 is added to the savability information ENm from the savability information generation unit 165. Furthermore, in the recording time code adding unit 166, the savability information ENm to which the recording time code is added is wirelessly transmitted to the recording image instruction device 2 through the wireless transceiving unit 110. The information relating to the recording image corresponds to the savability information ENm to which the recording time code is added which is output from the instructed image recording unit 16. The recording time code adding unit 166 is one example of a second time code adding unit of an embodiment of the disclosure.

Further, as described above, since a response of an image recording instruction or an image erasing instruction is sent from the recording image instruction device 2 to the respective pieces of information relating to the transmitted recording images, the wireless transceiving unit 110 receives the response and transfers the response to the recording and erasing instruction detection determination unit 111.

The recording and erasing instruction detection determination unit 111 determines whether the response is an image recording instruction or an image erasing instruction, and supplies the determination output to the instructed image recording unit 16 along with the recording time code. The recording and erasing instruction detection determination unit 111 is one example of a determination unit of an embodiment of the disclosure.

Here, the storage processing method of each frame in the image temporary storage unit 162 described above is one example, and the storage processing method is not limited to such a method.

### 4. Configuration Example of Recording Image Instruction Device

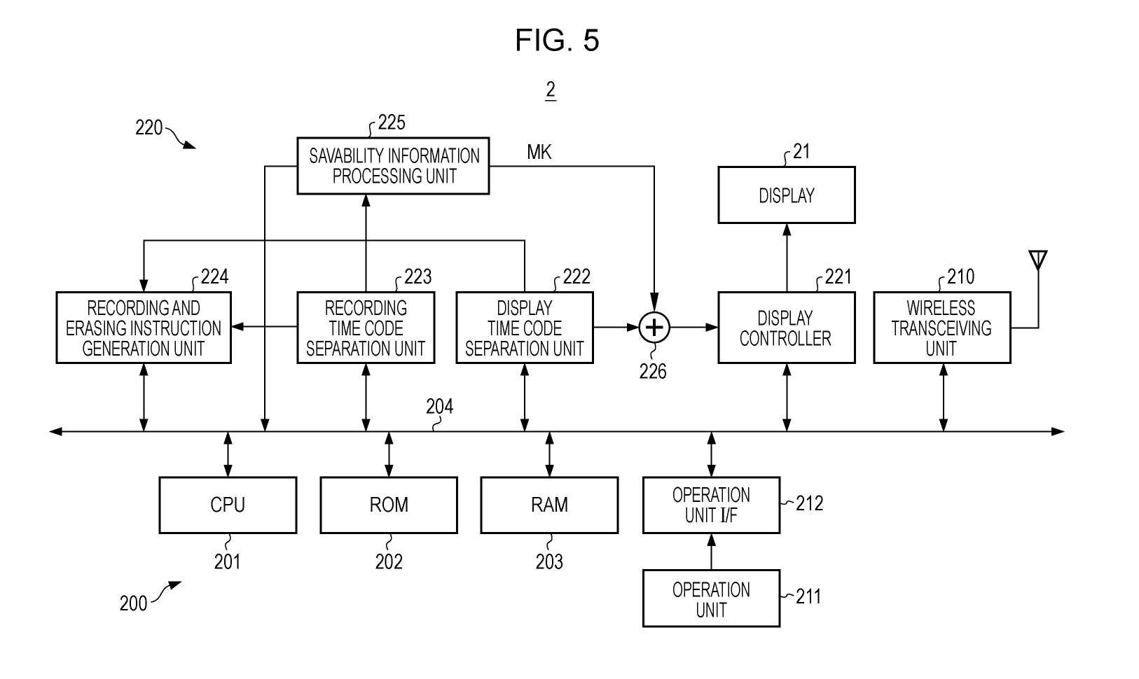

Next, a block diagram of a configuration example of the recording image instruction device 2 is illustrated in FIG. 5. The recording image instruction device 2 of the example has a configuration of including a control unit 200, a wireless transceiving unit 210, an operation unit 211 that includes a shutter button, and a display and recording and erasing instruction generation unit 220. The wireless transceiving unit 210 is one example of a second transmission unit of an embodiment of the disclosure.

The control unit 200 includes a microcomputer that is configured to have a CPU 201, a ROM 202 in which programs are stored, and a RAM 203 that is used as a work area connected to a system bus 204.

In the example, a transmitting input end and a receiving output end of the wireless transceiving unit 210 are connected to the system bus 204, and transmission information is supplied to the wireless transceiving unit 210 through the system bus 204. Further, the wireless transceiving unit 210 is configured so that information that is received by the wireless transceiving unit 210 is supplied to each of the units under the control of the control unit 200 through the system bus 204.

Further, the operation unit 211 is connected to the system bus 204 through an operation interface 212. In the example, as illustrated in FIG. 1, the operation unit 211 includes the shutter button 22 and the like.

When any of the buttons of the operation unit 211 is operated, the operation input signal thereof is supplied to the system bus 204 through the operation unit interface 212. The CPU 201 of the control unit 200 recognizes which button is operated according to a detection program of operation inputs in the operation unit 211 of the ROM 202, and operates software processing that corresponds to the operated button according to the recognition result.

The display and recording and erasing instruction generation unit 220 is composed of the display 21, a display controller 221, a display time code separation unit 222, a recording time code separation unit 223, a recording and erasing instruction generation unit 224, a savability information processing unit 225, and a savability display addition unit 226. Here, the display time code separation unit 222, the recording time code separation unit 223, the recording and erasing instruction generation unit 224, the savability information processing unit 225, and the savability display addition unit 226 are able to be configured as software processing by a microcomputer that configures the control unit 200.

The display 21 is connected to the system bus 204 through the display controller 221. The display controller 204 performs image display on the display 21 while being controlled by the control unit 200.

The display time code separation unit 222 receives the information that relates to the display image that is received from the capturing image recording device 1 by the wireless transceiving unit 210 through the system bus 204 and separates the display time code from the information that relates to the display image. Furthermore, the display time code separation unit 222 supplies the time code to the system bus 204 and the recording and erasing instruction generation unit 224 and supplies the display image signal to the savability display addition unit 226.

The recording time code separation unit 223 receives the information that relates to the display image that is received from the capturing image recording device 1 by the wireless transceiving unit 210 through the system bus 204 and separates the recording time code from the information that relates to the display image. Furthermore, the recording time code separation unit 223 supplies the recording code to the recording and erasing instruction generation unit 224 and supplies the savability information ENm to the savability information processing unit 225.

In the example, the savability information processing unit 225 determines the savability conditions from the savability information ENm and transmits the determination result to the system bus 204. Further, the savability information processing unit 225 generates savability display information MK from the determined savability conditions. The savability display information MK is display information of, for example, a “◯” mark when the savability conditions allow saving and is display information of a “x” mark when saving is difficult. The savability display information MK is supplied to the savability display addition unit 226. As described above, as the savability display information MK, numerical display information that indicates the number of savable frames may be used instead of the “◯” mark or the “x” mark.

Furthermore, the savability information addition unit 226 adds the savability display information to the display image signal and supplies the display image signal of the addition result to the display controller 221. The display controller 221 displays an image by the display image signal to which the savability display information is added as a monitor display image during capturing on the screen of the display 21.

### 5. Generation and Transmission of Response from Image Recording Instruction or Image Erasing Instruction

The control unit 200 ascertains whether or not there is an operation to press down on the shutter button 22 of the operation unit 211 through the operation unit interface 212, monitors each display image that is displayed on the display 21, and supplies the monitoring result to the recording and erasing instruction generation unit 224.

The recording and erasing instruction generation unit 224 receives the monitoring result of whether or not there has been an operation to press down on the shutter button 22 from the control unit 100, and generates a response to the information relating to the recording image that is received by the wireless transceiving unit 210 according to the monitoring result.

### Generation and Transmission of Response Composed of Image Recording Instruction

The recording and erasing instruction generation unit 224 generates, in a case when a monitoring result that there was an operation to press down on the shutter button 22 is received, an image recording instruction as the response. At this time, the recording and erasing instruction generation unit 224 detects a recording time code that is being supplied from the recording time code separation unit 223.

Furthermore, the recording and erasing instruction generation unit 224 sends the recording image instruction that includes the detected recording time code to the system bus 204. The control unit 200 transmits the image recording instruction as a response to the information relating to the recording image to the capturing image recording device 1 through the wireless transceiving unit 210. Here, the control unit 200 may also include the deviation amount described above in the recording image instruction.

### Generation and Transmission of Response Composed of Image Erasing Instruction

Further, the recording and erasing instruction generation unit 224 generates, in a case when a monitoring result that there was an operation to press down on the shutter button 22 is not received, an image erasing instruction as the response.

In the example, the recording and erasing instruction generation unit 224 detects a time point at which the image erasing instruction is generation as a changed time point of the recording time code from the recording time code unit 223.

Furthermore, the recording and erasing instruction generation unit 224 determines the recording time code to be included in the image erasing instruction.

The control unit 200 transmits the image erasing instruction from the recording and erasing instruction generation unit 224 as a response to the information relating to the recording image to the capturing image recording device 1 through the wireless transceiving unit 210. Here, the control unit 200 may include the deviation amount described above in the recording erasing instruction.

Here, in the description above, the response composed of the image erasing instruction is sent to the capturing image recording device 1 in order to explicitly show the erasable instruction of a recording image signal with no recording instruction. However, without including the explicit information that is the erasable instruction, a response that only includes a recording time code may be returned to the capturing image recording device 1, and the capturing image recording device 1 may determine such a response as an erasable instruction. The same is also true of the embodiments below.

### 6. Flowchart of Processing Operation of Capturing Image Recording Device (First Embodiment)

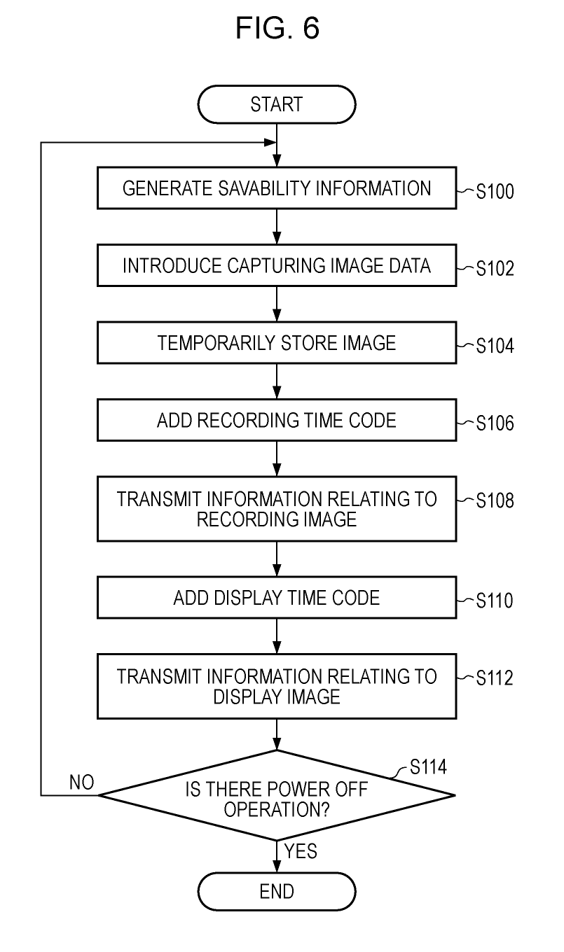

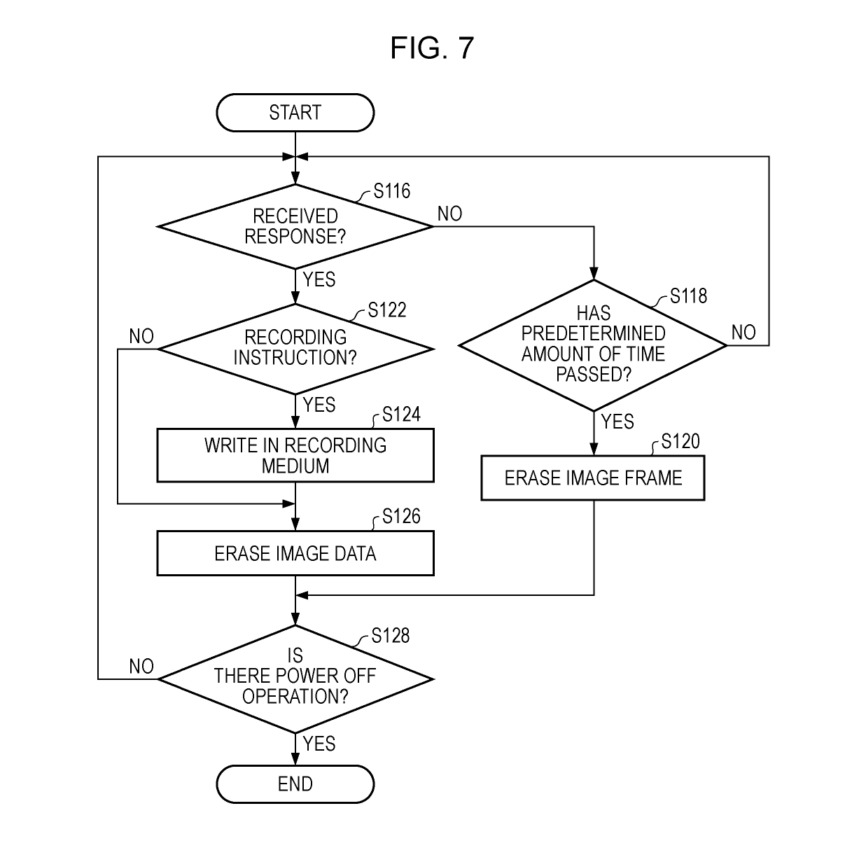

The processing operations of the capturing image recording device 1 when capturing image recording processing as described above will be described with reference to the flowcharts of FIG. 6 and FIG. 7.

FIG. 6 is a flowchart describing processing operations for the transmission of information relating to a display image and information relating to a recording image from the capturing image recording device 1 to the recording image instruction device 2.

When the power is turned on for the capturing image recording device 1, the control unit 100 of the capturing image recording device 1 starts the processing from the beginning of FIG. 6. Furthermore, the control unit 100 first controls the savability information generation unit 165 of the instructed image recording unit 16, calculates the spare storage capacity of the image temporary storage unit 162, that is, the number of savable frames, and causes the savability information ENm to be generated (step S100). The savability information generation unit 165 calculates the number of savable frames from the detection result of detecting unrecorded regions and erasable regions of the image temporary storage unit 162.

Next, the control unit 100 performs controls to start introducing capturing image data from the imaging element 12 (step S102). Furthermore, under the control of the control unit 100, recording image signals of frame units are generated by the recording image signal generation unit 14, and recording time codes are associated with recording image signals at the time code association unit 161 of the instructed image recording unit 16. Furthermore, recording image signals to which recording time codes are added are stored in the image temporary storage unit 162 (step S104).

Further, under the control of the control unit 100, in the recording time code adding unit 166, recording time codes from the time code association unit 161 are added to the savability information ENm from the savability information generation unit 165 (step S104).

Next, the control unit 100 performs control such that the savability information ENm to which recording time codes are added is wirelessly transmitted to the recording image instruction device 2 as information relating to the recording image described above (step S108).

Further, under the control of the control unit 100, in the display image signal generation unit 15, a display time code is added to the display image data from the resolution changing unit 151 (step S110).

Next, the control unit 100 performs control such that the display image data to which display time codes are added is wirelessly transmitted to the recording image instruction device 2 as information relating to the display image described above (step S112).

Next, the control unit 100 determines whether or not a power OFF operation has been performed (step S114), and if it is determined that a power OFF operation has not been performed, step S100 is returned to, and the processes of step S100 and thereafter are repeated. Further, in a case when it is determined in step S114 that a power OFF operation has been performed, the control unit 100 ends the processing routine of the transmission of FIG. 6.

FIG. 7 is a flowchart describing processing operations for the capturing image recording device 1 to receive responses to the respective pieces of information that relate to the recording image from the recording image instruction device 2.

First, the control unit 100 determines whether or not a response composed of an image recording instruction or an image erasing instruction is received (step S116). When it is determined in step S116 that a response is not received, the control unit 100 determines whether or not a predetermined amount of time determined in advance or longer has passed since the information relating to the recording image was sent (step S118). Here, the length of the predetermined amount of time for monitoring is a length of time, for example, such that is possible to tell that a wireless connection between the capturing image recording device 1 and the recording image instruction device 2 has been disconnected.

When it is determined in step S118 that the predetermined amount of time has not passed, returning to step S116, the control unit 100 monitors reception of a response. Further, when it is determined in step S118 that the predetermined amount of time or longer has not passed, the control unit 100 makes the storage region of the image temporary storage unit 162 of the image frame of the recording time code for which a response was not received within the predetermined amount of time an erasable region (step S120).

Furthermore, when the control unit 100 determines whether or not a power OFF operation has been performed (step S128) and it is determined that a power OFF operation has not been performed, step S116 is returned to and the processes of step S116 and thereafter are repeated. Further, when it is determined in step S128 that a power OFF operation has been performed, the control unit 100 ends the processing routine of FIG. 7.

When it is determined in step S116 that a response has been received, the control unit 100 determines whether or not the received response is an image recording instruction (step S122). Furthermore, when it is determined in step S122 that a recording image instruction has been received, the control unit 100 controls the recording instructed image specifying unit 163 and causes the recording time code of the capturing image that is to be actually recorded based on the received recording image instruction. Furthermore, under the control of the control unit 100, the recording instructed image specifying unit 163 reads the recording image signal to which the specified recording time code is added from the image temporary storage unit 162, compresses the recording image signal by the image compression processing unit 164, and records the recording image signals in the recording medium 17 (step S124).

Furthermore, following step S124, the control unit 100 makes the storage unit of the image temporary storage unit 162 in which the image data of the recording time code that was included in the image recording instruction was stored an erasable region (step S126).

When it is determined in step S122 that the response is not a recording image instruction, skipping step S124 and proceeding to step S126, the control unit 100 makes the storage unit of the image temporary storage unit 162 in which the image data of the recording time code that was included in the image recording instruction was stored an erasable region.

After step S126, proceeding to step S128, the control unit 100 determines whether or not the power has been turned OFF, and when it is determined that the power has not been turned OFF, step S116 is returned to and the processing operations described above are repeated. Further, when it is determined that the power has been turned OFF in step S128, the control unit 100 ends the processing routine.

### 7. Flowchart of Processing Operation of Recording Image Instruction Device (First Embodiment)

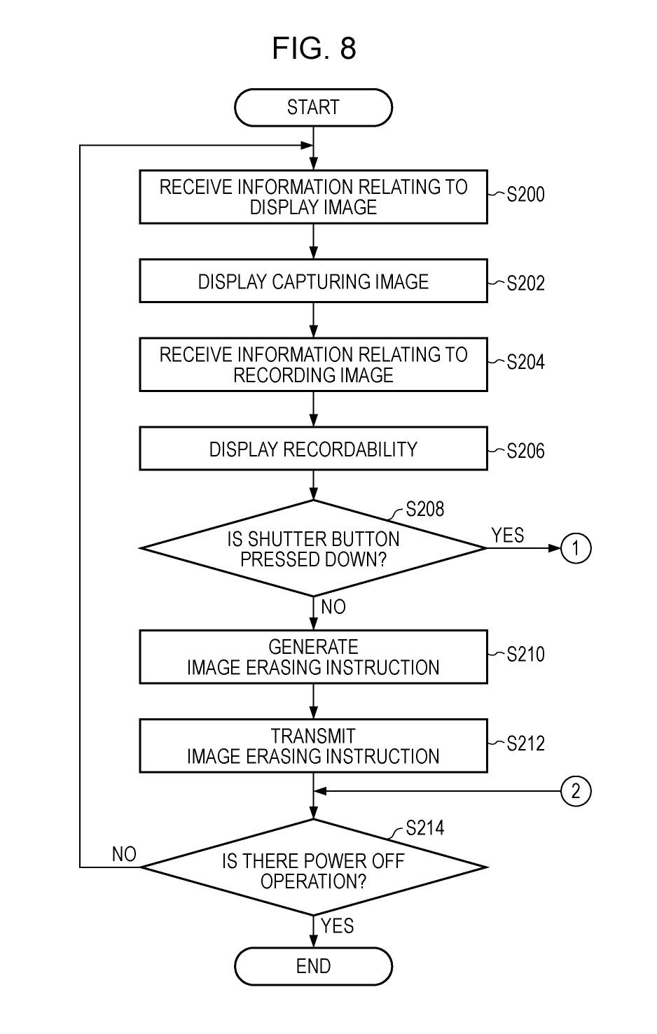

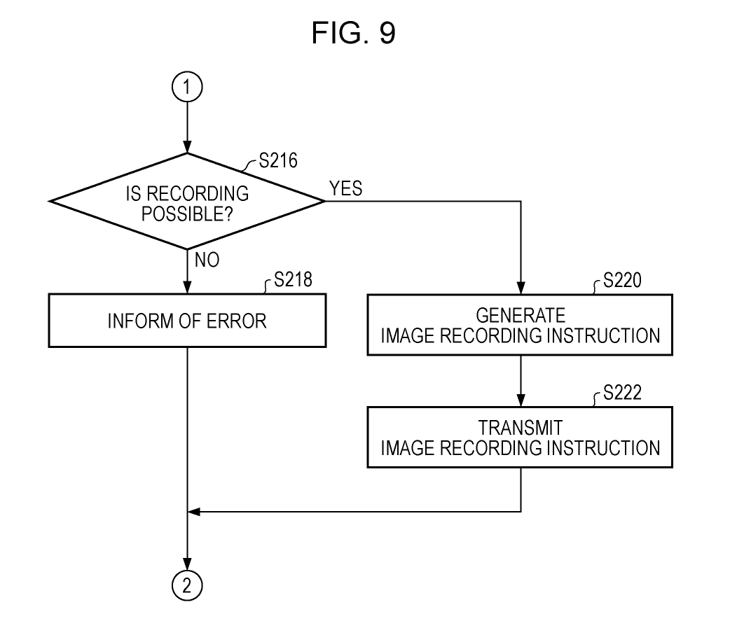

Next, the processing operations of the recording image instruction device 2 during the capturing image recording processing described above will be described with reference to the flowcharts of FIGS. 8 and 9.

The recording image instruction device 2 receives the display image signal to which a display time code is added from the capturing image recording device 1 by the wireless transceiving unit 210, and sends the display image signal to the system bus 204 (step S200). The control unit 200 transfers the received display image signal to which the display time code is added to the display time code separation unit 222.

The display time code separation unit 222 separates the display time code from the display image signal that is transferred and supplies the separated display time code to the system bus 204 and the recording and erasing instruction generation unit 224, and also sends the display image signal to the display 21 through the display controller 221. In so doing, the monitor display image of a capturing image is displayed on the display 21 (step S202).

Further, the recording image instruction device 2 receives the savability information ENm to which a recording time code is added from the capturing image recording device 1 by the wireless transceiving unit 210 and sends the savability information ENm to the system bus 204 (step S204). The control unit 200 transfers the received savability information ENm to which the recording time code is added to the recording time code separation unit 223.

The recording time code separation unit 223 separates the recording time code from the transferred savability information ENm and supplies the separated recording time code to the system bus 204 and the recording and erasing instruction generation unit 224 and also supplies the savability information ENm to the savability information processing unit 225. The savability information processing unit 225 determines whether the savability information ENm is savable or is not savable, and conveys the determination result to the control unit 100. Further, the savability processing unit 225 generates a savability display from the determination result of savability, and superimposes the savability display on the display image (step S206).

Next, the control unit 200 monitors whether or not the user operates to press down on the shutter button 22 (step S208). When it is determined in step S208 that an operation to press down on the shutter button 22 has not been performed, the control unit 200 controls the recording and erasing instruction generation unit 224 so that an image erasing instruction is generated.

That is, the recording and erasing instruction generation unit 224 confirms the recording time code of the recordable image to which the image erasing instruction is returned as a response. Furthermore, the recording and erasing instruction generation unit 224 generates an image erasing instruction that includes the confirmed recording time code as a response (step S210).

Furthermore, the control unit 200 supplies the response composed of the image erasing instruction to the wireless transceiving unit 210 and causes the response to be wirelessly transmitted to the capturing image recording device 1 (step S212). In addition, proceeding to step S214, the control unit 200 determines whether or not the power is OFF, and when it is determined that the power is not OFF, step S200 is returned to and the processing operations described above are repeated. Further, when it is determined in step S214 that the power is OFF, the control unit 200 ends the processing routine.

Further, when it is determined in step S208 that the shutter button 22 is operated to be pressed down by the user, the control unit 200 references the savability determination result from the savability information processing unit 225 and determines whether or not saving is possible (recordable) (step S216 of FIG. 9).

When it is determined in step S216 that the image temporary storage unit 162 is in a state in which there is nothing saved and recording is difficult, the control unit 100 informs the user of an error (step S218). The informing of an error is performed, for example, by displaying a message that recording is difficult on the display 21, sounding a warning sound, combining the message display and the warning sound, or the like.

Step S214 is proceeded to after step S218, and the processes of step S214 described above and thereafter are repeated.

Further, when it is determined in step 5216 that recording is difficult, the control unit 200 notifies the recording and erasing instruction generation unit 224 that an operation to press down on the shutter button 22 has been performed by the user. The recording and erasing instruction generation unit 224 confirms, based on the notification, the recording time code that is supplied when the shutter button 22 is operated to be pressed down from the recording time code separation unit 223 as the recording time code of the recordable image to be recorded. Furthermore, the recording and erasing instruction generation unit 224 generates an image recording instruction that includes the confirmed recording time code and sends the image recording instruction to the system bus 204 (step S220).

Furthermore, the control unit 200 supplies the image recording instruction to the wireless transceiving unit 210 and causes the image recording instruction to be wirelessly transmitted to the capturing recording device 1 (step S222). In addition, proceeding to step S214, when it is determined whether or not the power has been turned OFF and it is determined that the power has not been turned OFF, step S200 is returned to and the processing operations described above are repeated. Further, when it is determined in step S214 that the power has been turned OFF, the control unit 100 ends the processing routine.

As above, according to the first embodiment described above, even in a case when a delay occurs in the transmission of information between the capturing image recording device 1 and the recording image instruction device 2, it is possible to reliably record a capturing image based on a capturing image that the user verifies on a display screen of the recording image instruction device 2 by the capturing image recording device 1.

Further, according to the embodiment, it is possible to return a response to information relating to the recording image from the recording image instruction device 2 to the capturing image recording device 1 and to erase recording image signals from the image temporary storage unit 162. Therefore, unnecessary image data is not stored on the image temporary storage unit 162 and storage regions for new capturing images are able to be secured.

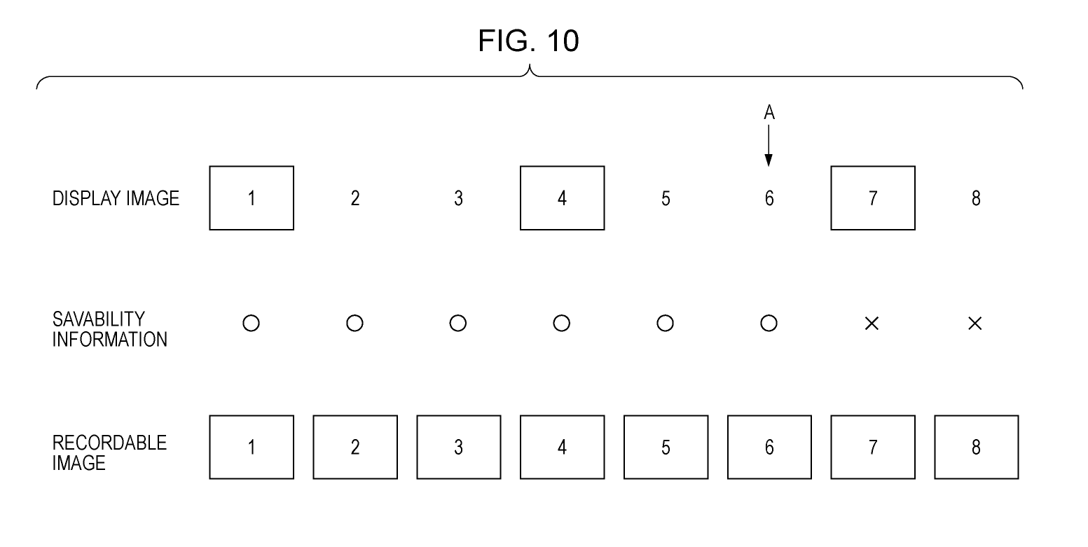

Further, according to the embodiment, as illustrated in FIG. 10, in a case when the frame rate of a display image is lower than the frame rate of a recordable image, it is possible, for example, at a point in time when the time code is 6, for the user to determine that the capturing image at the point in time when the time code that the user intends is 6 is recordable. Furthermore, by the user performing a shutter operation at a point in time when the time code is 6, the capturing image at the point in time when the time code that the user intends is 6 is recorded.

### 8. Configuration Example of Capturing Image Recording Device in Image Recording Device (Second Embodiment)

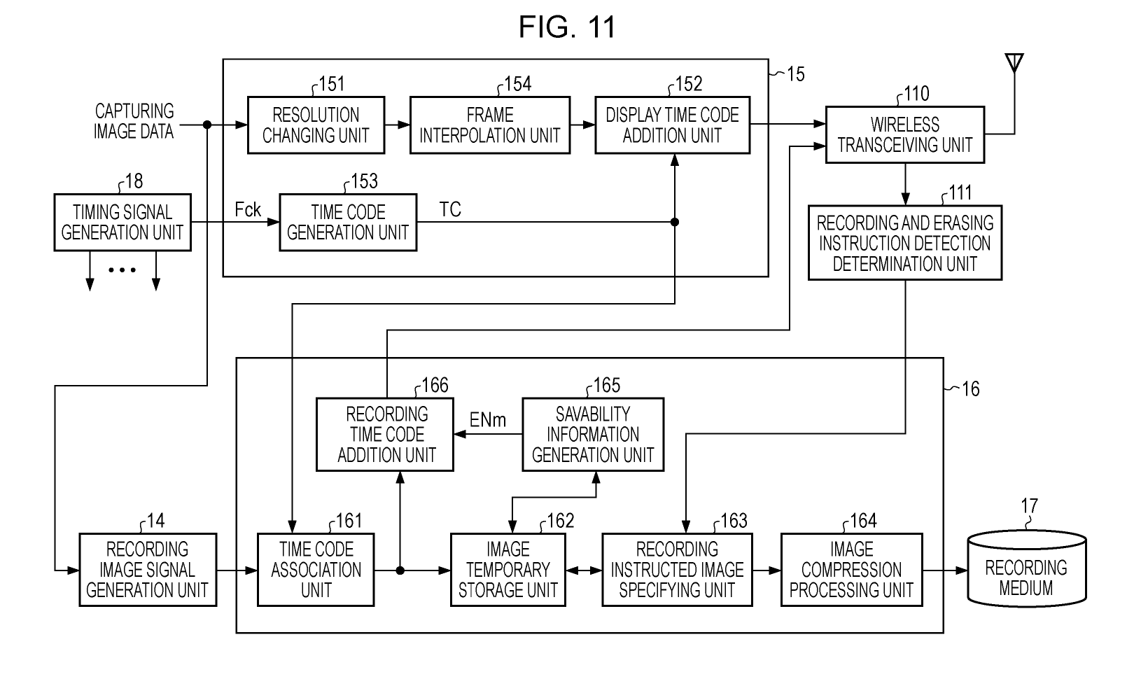

Next, a configuration example of a capturing image recording device in an image recording device according to a second embodiment of the disclosure will be described. FIG. 11 is an explanatory diagram for describing a configuration example of a capturing image recording device in the image recording device according to the embodiments. Since the only differences from the first embodiment described above are that the capturing image recording device of the present embodiment uses a slow shutter speed due to dark subjects or special effects, the capturing frame rate is lower than the transmission frame rate, and the display image signal generation unit 15 includes a frame interpolation unit 154, description of duplicate configurations and operations is omitted, and description of configurations and operations that are different will be made below.

In FIG. 11, the display image signal generation unit 15 includes the resolution changing unit 151, the display time code adding unit 152, the time code generation unit 153, and the frame rate interpolation unit 154.

The resolution changing unit 151 generates display image data with a resolution that is based on control information of the display resolution from the control unit 100 with the capturing image data from the capturing signal generation unit 13, and supplies the generated display image data to the frame interpolation unit 154.

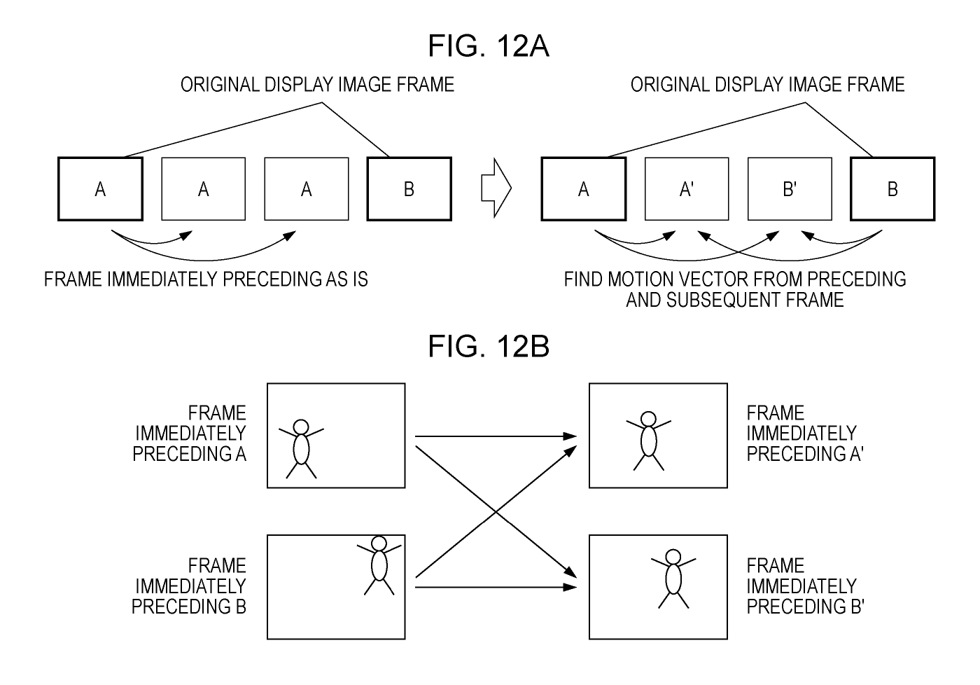

The frame interpolation unit 154 performs frame interpolation on display images that are input at the capturing frame rate, and supplies the display images to the display time code adding unit 152 at the transmission frame rate. The frame interpolation unit 154 performs, for example, as illustrated in FIGS. 12A and 12B, frame interpolation by finding the motion vector from the preceding and the following frame. Here, the technique of the frame interpolation by the frame interpolation unit 154 is not limited to the above.

In the display time code adding unit 152, the time codes TC (display time codes) are added to the display image data from the frame interpolation unit 154 by frame units. Furthermore, the display time code adding unit 152 wirelessly transmits the display image data on which the display time coded are added to the recording image instruction device 2 through the wireless transceiving unit 110.

### 9. Flowchart of Processing Operation in Capturing Image Recording Device (Second Embodiment)

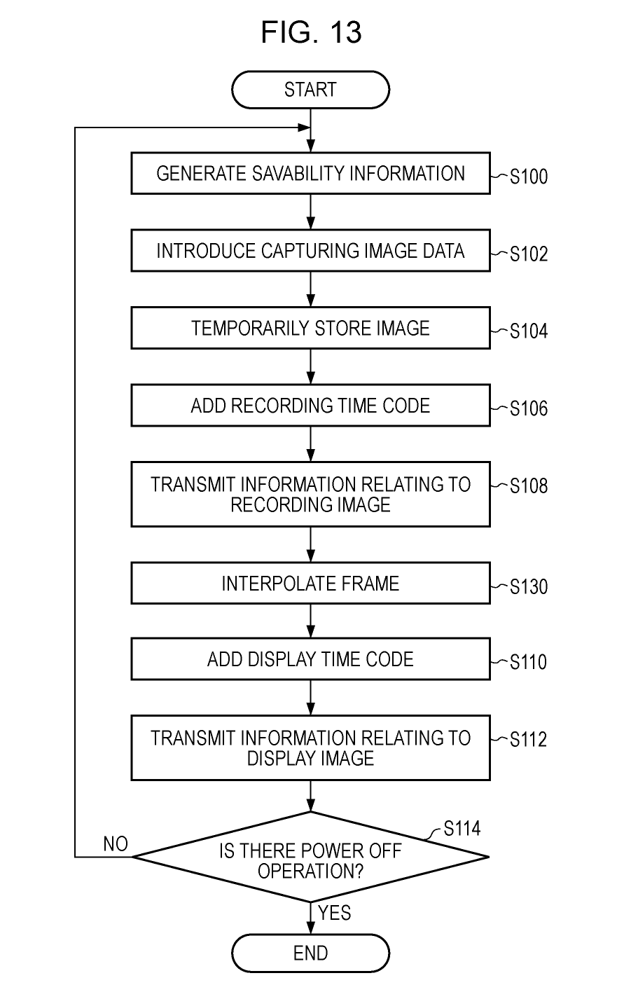

Next, the processing operations of the capturing image recording device according to an image recording device according to the second embodiment of the disclosure will be described with reference to the flowchart of FIG. 13. Since the only difference from the first embodiment described above is that frame interpolation is performed in the processing operations of the capturing image recording device in the present embodiment, duplicate description will be omitted.

FIG. 13 is a flowchart describing processing operations for the transmission information relating to a display image and information relating to a recording image from the capturing image recording device 1 to the recording image instruction device 2.

After the processes of step S100 to step S108 described above are executed, frame interpolation of the display image data from the resolution changing unit 151 is performed in the display image signal generation unit 15 under the control of the control unit 100 (step S130).

Next, in the display image signal generation unit 15, display time codes are added to the display image data from the frame interpolation unit 154 under the control of the control unit 100 (step S110). Furthermore, the processes of steps S112 and S114 described above are executed.

According to the embodiment, it is possible to maintain a fixed transmission frame rate even in a case when a slow shutter speed is used for dark subjects or special effects and the capturing frame rate is lower than the transmission frame rate.

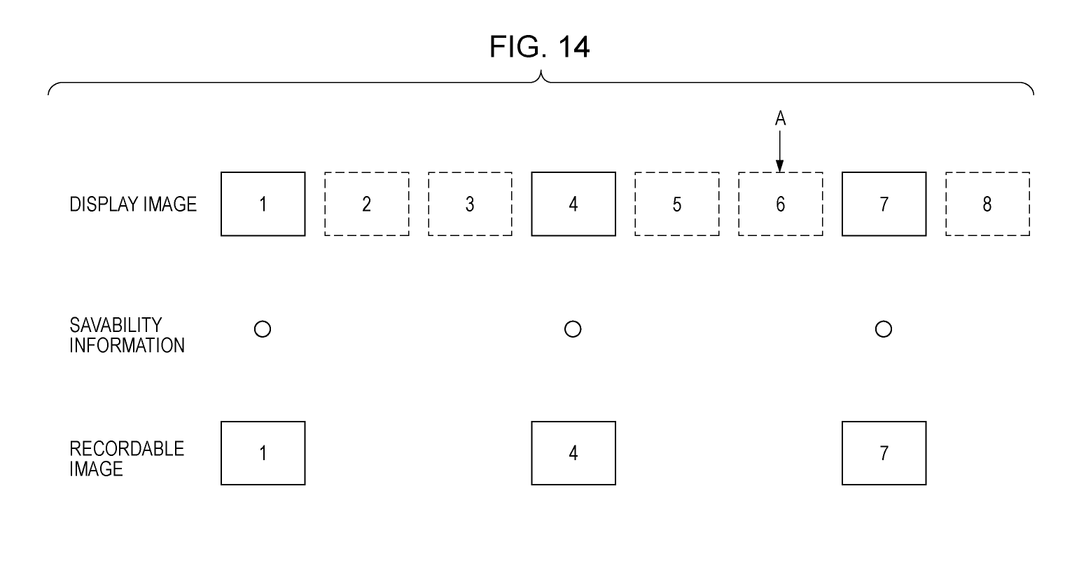

Further, according to the embodiment, as illustrated in FIG. 14, since time codes are also added to display images enclosed by the broken lines which have been frame interpolated in a case when the frame rate of a display image is higher than the frame rate of a recordable image, when the user performs a shutter operation, for example, at a point in time when the time code is 6, it is possible to accurately ascertain the capturing timing that the user intends when the time code is 6.

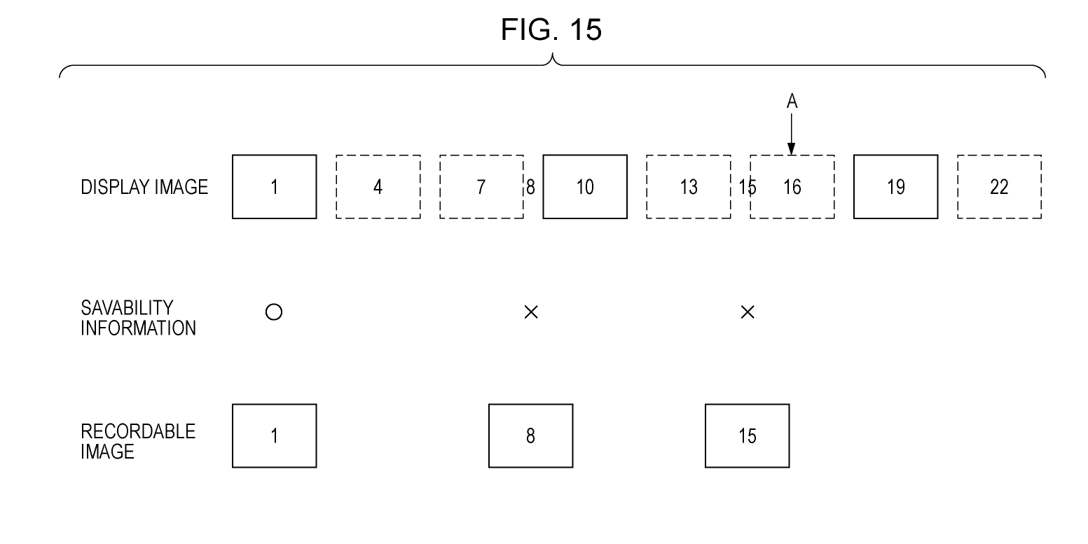

Further, according to the embodiment, as illustrated in FIG. 15, since time codes are also added to display images enclosed by the broken lines which have been frame interpolated in a case when the frame rate of a display image is higher than the frame rate of a recordable image and the frame rate is not an integral multiple, for example, it is possible for the user to determine at a point in time when the time code is 16 that a capturing image at a point in time when the time code is 15 immediately before the point in time when the time code that the user intends is 16 is not recordable.

### Instruction Device in Image Recording Device (Second Embodiment)

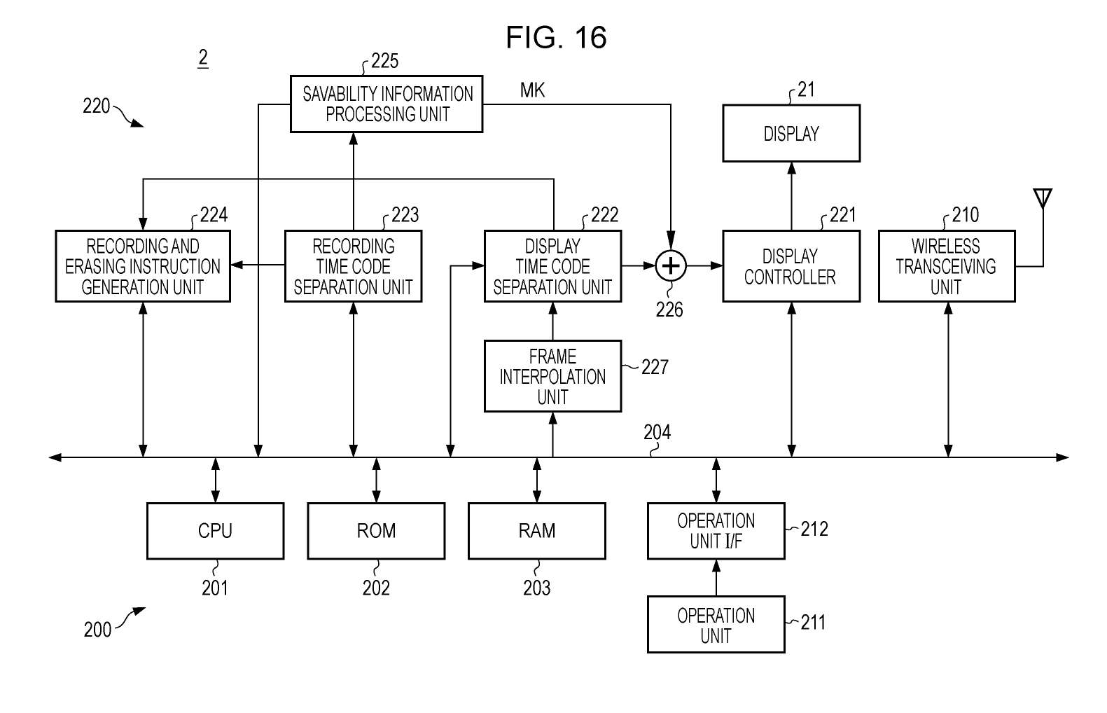

Next, a configuration example of a recording image instruction device of the image recording device according to the second embodiment of the disclosure will be described. FIG. 16 is an explanatory diagram for describing a configuration example of the recording image instruction device in the image recording device according to the embodiment. Since the only differences from the first embodiment described above are that in the recording image instruction device of the present embodiment, the display frame rate is higher than the transmission frame rate and the display and recording and erasing instruction generation unit 220 includes a frame interpolation unit 227, description of duplicate configurations and operations is omitted, and description of configurations and operations that are different will be made below.

In FIG. 16, the display and recording and erasing instruction generation unit 220 is composed of the display 21, the display controller 221, the display time code separation unit 222, the recording time code separation unit 223, the recording and erasing instruction generation unit 224, the savability information processing unit 225, the savability display addition unit 226, and the frame interpolation unit 227. Here, the display time code separation unit 222, the recording time code separation unit 223, the recording and erasing instruction generation unit 224, the savability information processing unit 225, the savability display addition unit 226, and the frame interpolation unit 227 may be configured as software processes by a microcomputer that configures the control unit 200.

The frame interpolation unit 227 receives information relating to the display image that is received from the capturing image recording device 1 by the wireless transceiving unit 210 through the system bus 204, performs frame interpolation on the display image that is input at the transmission frame rate, and supplies the display image to the display time code separation unit 222 at the display frame rate. Further, the frame interpolation unit 227 performs interpolation on the time code of the display image. The frame interpolation unit 227 performs frame interpolation, for example, as illustrated in FIGS. 12A and 12B, by finding the motion vector from the preceding and following frames. Here, the technique of the frame interpolation by the frame interpolation unit 227 is not limited to the above.

The display time code separation unit 222 receives the information relating to the display image from the frame interpolation unit 227 and separates the display time code from the information relating to the display image. Furthermore, the display time code separation unit 222 supplies the display time code to the system bus 204 and the recording and erasing instruction generation unit 224 and supplies the display image signal to the savability display addition unit 226.

### 11. Flowchart of Processing Operation in Recording Image Instruction Device (Second Embodiment)

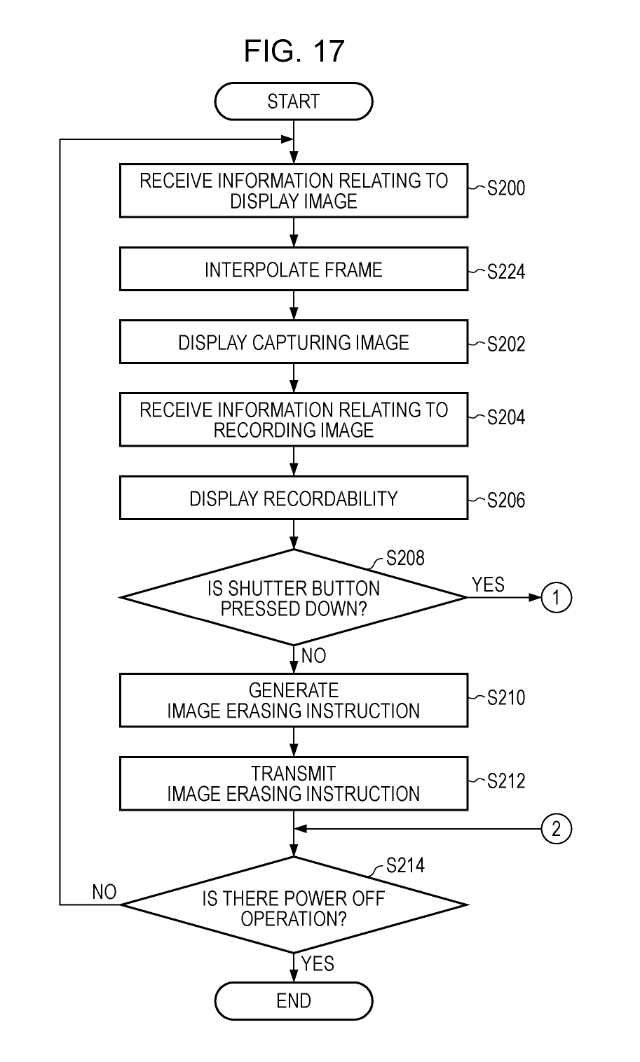

Next, the processing operations of the recording image instruction device in the image recording device according to the second embodiment of the disclosure will be described with reference to the flowchart of FIG. 17. Since the only difference from the first embodiment described above is that frame interpolation is performed in the processing operations of the capturing image recording device in the present embodiment, duplicate description will be omitted.

The recording image instruction device 2 receives display image signals to which display time codes are added from the capturing image recording device 1 by the wireless transceiving unit 210 and sends the display image signals to the system bus 204 (step S200). The control unit 200 transfers the received display image signals on which the display time codes are added to the frame interpolation unit 227.

Next, frame interpolation is performed on the transferred display image signals by the frame interpolation unit 227 under the control of the control unit 200. Further, the frame interpolation unit 227 also performs interpolation on the display time codes of the transferred display image signals (step S224).

The display time code separation unit 222 separates the display time codes from the transferred display image signals and supplies the separated display time code to the system bus 204 and the recording and erasing instruction generation unit 224, and also sends the display image signals to the display 21 through the display controller 221. In so doing, a monitor display image of the capturing image is displayed on the display 21 (step S202). Furthermore, the processes of steps S204 to S214 described above are executed.

According to the embodiment, even a case in which the display frame rate is higher than the transmission frame rate is compatible. Furthermore, according to the embodiment, since interpolation is also performed on the display time codes of the display image signals, it is also possible for the user to accurately ascertain the capturing timing of a display image that is frame interpolated.

### 12. Configuration Example of Capturing Image Recording Device in Image Recording Device (Third Embodiment)

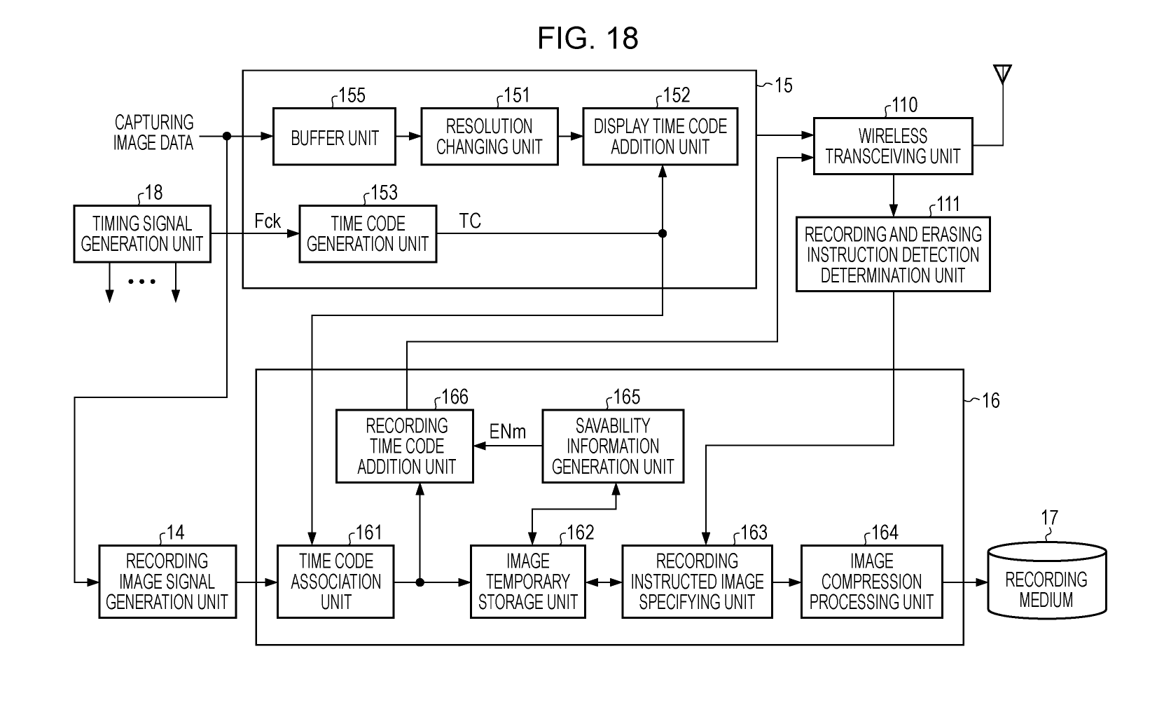

Next, a configuration example of a capturing image recording device of an image recording device according to a third embodiment of the disclosure will be described. FIG. 18 is an explanatory diagram for describing a configuration example of the capturing image recording device in the image recording device according to the embodiment. Since the only differences from the first embodiment described above are that in the capturing image recording device of the present embodiment, the capturing frame rate is higher than the transmission frame rate and the display image signal generation unit 15 includes a buffer unit 155, description of duplicate configurations and operations is omitted, and description of configurations and operations that are different will be made below.

In FIG. 18, the display image signal generation unit 15 includes the resolution changing unit 151, the display time code adding unit 152, the time code generation unit 153, and the buffer unit 155.

The buffer unit 155 performs buffering of capturing image data that is input from the capturing signal processing unit 13 at the capturing frame rate, and supplies the capturing image data to the resolution changing unit 151 at the transmission frame rate.

The resolution changing unit 151 generates display image data with a resolution that is based on control information of the display resolution from the control unit 100 with the capturing image data from the buffer unit 155, and supplies the generated display image data to the display time code adding unit 152.

According to the embodiment, even in a case when the capturing frame rate is higher than the transmission frame rate, by transmitting all image frames using the buffer unit 155, slow reproduction is able to be realized.

### 13. Configuration Example of Recording Image Instruction Device in Image Recording Device (Third Embodiment)

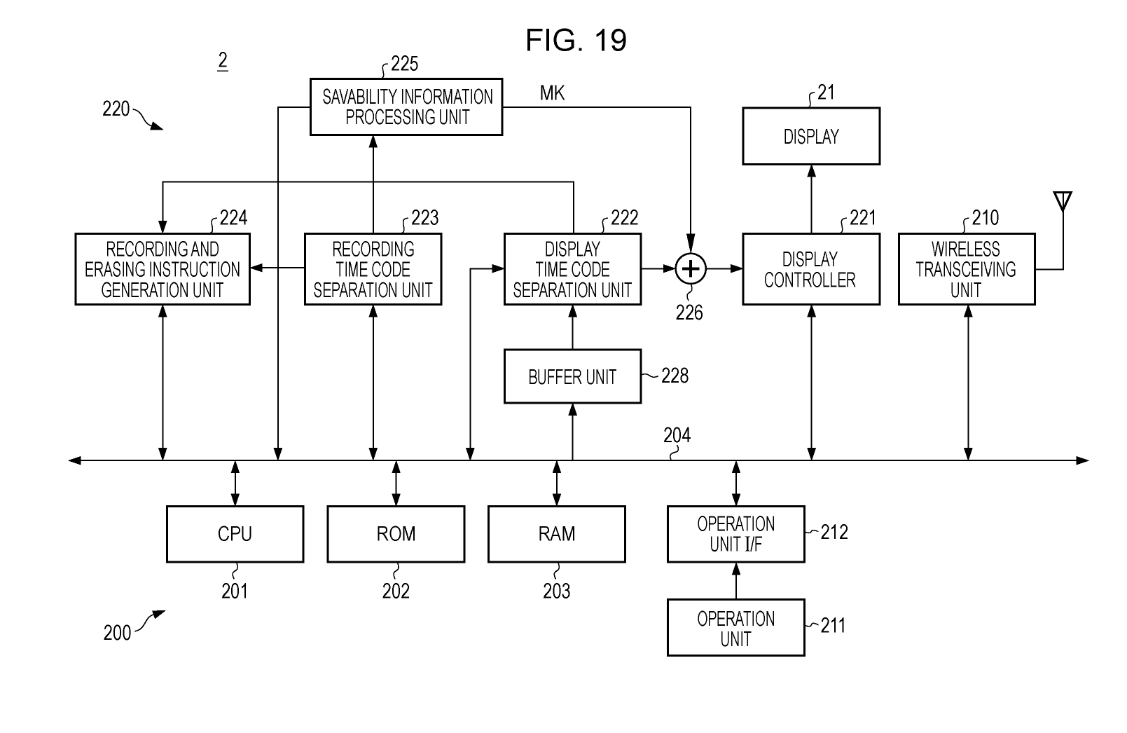

Next, a configuration example of a recording image instruction device in an image recording device according to the third embodiment of the disclosure will be described. FIG. 19 is an explanatory diagram for describing a configuration diagram of the recording image instruction device in the image recording device according to the embodiment. Since the only differences from the first embodiment described above are that in the recording image instruction device of the present embodiment, the transmission frame rate is higher than the display frame rate and the display and recording and erasing instruction generation unit 220 includes a buffer unit 228, description of duplicate configurations and operations is omitted, and description of configurations and operations that are different will be made below.

In FIG. 19, the display and recording and erasing instruction generation unit 220 includes the display 21, the display controller 221, the display time code separation unit 222, the recording time code separation unit 223, the recording and erasing instruction generation unit 224, the savability information processing unit 225, the savability display addition unit 226, and the buffer unit 228. Here, the display time code separation unit 222, the recording time code separation unit 223, the recording and erasing instruction generation unit 224, the savability information processing unit 225, the savability display addition unit 226, and the buffer unit 228 may be configured as software processes by a microcomputer that configures the control unit 200.

The buffer unit 228 performs buffering of the information relating to the display image that is received by the wireless transceiving unit 210 from the capturing image recording device 1 at the transmission frame rate, and supplies the information relating to the display image to the display time code separation unit 222 at the display frame rate.

The display time code separation unit 222 receives the information relating to the display image from the buffer unit 228 and separates the display time code from the information relating to the display image. Furthermore, the display time code separation unit 222 supplies the display time code to the system bus 204 and the recording and erasing instruction generation unit 224 and supplies the display image signal to the savability display addition unit 226.

According to the embodiment, even in a case when the transmission frame rate is higher than the display frame rate, slow reproduction is possible by supplying all of the image frames using the buffer unit 228.

### 14. Processing Operations Based on Explicit Image Deletion Instruction by User

There may be a case when the user instructs recording with the recording image instruction device 2 but immediately thereafter wishes to stop recording of the image for which there is an instruction for recording. For such a reason, providing a deletion instruction button on the recording image instruction device 2 is considered.

In the embodiment described above, there has been no reference to such a process by the capturing image recording device of an instruction for deletion of a recording image based on the intent of the user from the recording image instruction device 2. Therefore, processing operations of the capturing image recording device based on the explicit instruction for image deletion by the user in the recording image instruction device 2 will be described below.

In such a case, in the recording image instruction device 2, when the user operates the deletion button after operating the shutter button, the recording image instruction device 2 transmits a recording image deletion instruction that includes recording time codes that were included in the recording instruction to the capturing image recording device 1. When the deletion instruction is received, the capturing image recording device 1 executes the deletion process of the recording image.

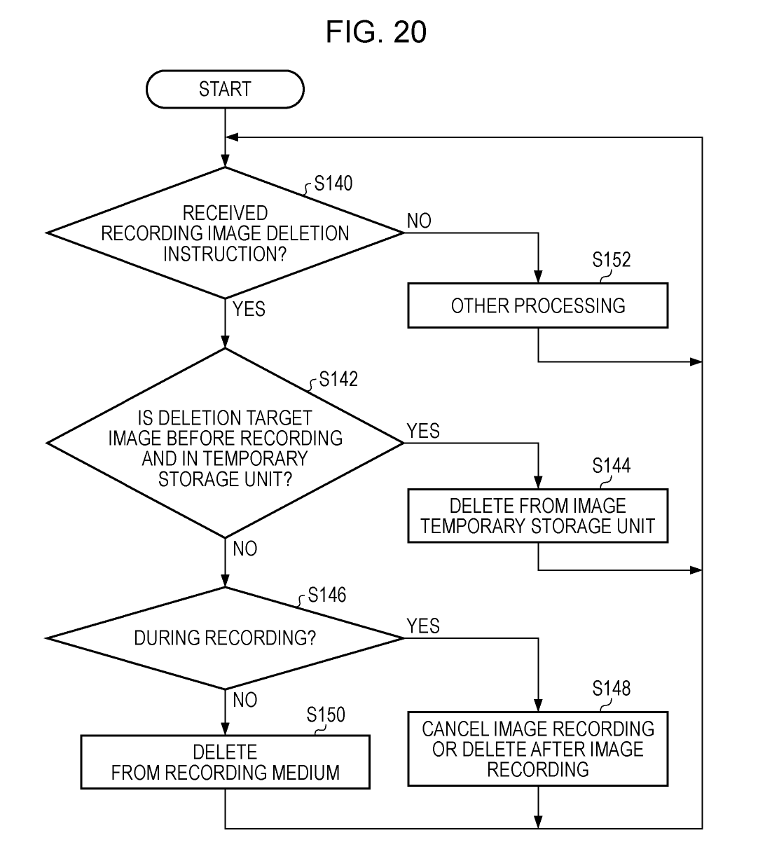

FIG. 20 is a flowchart describing the deletion processing operations in the capturing image recording device of the instruction for deletion of a recording image based on the intent of the user from the recording image instruction device 2.

The control unit 100 first determines whether or not a recording image deletion instruction is received from the recording image instruction device 2 (step S140), and if one is not received, executes other processes (step S152), after which step S140 is returned to.

When it is determined in step S140 that a recording image deletion instruction has been received, the control unit 100 recognizes the recording time code that is included in the recording image deletion instruction and determines whether or not a deletion target image that is specified by the recording time code is before being recorded in the recording medium and in the image temporary storage unit (step S142).

When it is determined in step S142 that the deletion target image is before being recorded in the recording medium and the entirety thereof is in the image temporary storage unit, the control unit 100 deletes the instructed image signals from the image temporary storage unit. Step S140 is then returned to.

Further, when it is determined in step S142 that recording of the deletion target image in the recording medium 17 has been started, the control unit 100 determines whether or not the deletion target image is in the process of being recorded in the recording medium 17 (step S146). When it is determined in step S146 that the deletion target image is in the process of being recorded, the control unit 100 cancels the recording operation of the deletion target image or deletes the recorded deletion target image from the recording medium 17 once the recording of the deletion target image has ended (step S150). Step S140 is then returned to.

When it is determined in step S146 that the deletion target image is not in the process of being recorded but has already been recorded in the recording medium 17, the control unit 100 deletes the recorded deletion target image from the recording medium 17 (step S148). Step S140 is then returned to.

### 15. Image Recording Device (Fourth Embodiment)

The embodiments described above have been a case when the image recording device is composed of one capturing image recording device and one recording image instruction device. On the other hand, the fourth embodiment is a case when there are a plurality of recording image instruction devices that are connected to one capturing image recording device.

The connection between one capturing image recording device and a plurality of recording image instruction devices is not limited to a connection by wireless communication paths, and may be a wired connection through a cable or a combination of wireless connection and wired connection.

In such a case, although the capturing image recording device supplies information relating to the display image thereof or information relating to a recording image in common to a plurality of recording image instruction devices, each of the recording image instruction devices includes a device identifier that indicates that an image recording instruction is from a given device in the image recording instruction.

In the capturing image recording device, when recording image frames in the recording medium 17, in order to be able to specify the recording image instruction device that has instructed image recording for the image frames at a later point in time as accompanying information thereof, the device identifiers of the recording image instruction devices which are included in the image recording instruction are recorded together in the recording medium 17.

In so doing, it is possible to recognize by which recording image instruction from which recording image instruction device the respective image frames of still images that are recorded in the recording medium 17 have been recorded. It therefore becomes easy to sort the recording images to reproduce or print output according to each of the plurality of recording image instruction devices.

Since common information relating to the display image or information relating to the recording image as described above is supplied from one capturing image recording device to a plurality of recording image instruction devices, there is no cause to separate and specify the plurality of recording image instruction devices that are the communication partners of the capturing image recording device. However, in a case when the capturing image recording device receives image recording instructions from a plurality of recording image instruction devices, there is cause to receive and separate each of the image recording instructions from the plurality of recording image instruction devices, and the method of separation poses a problem.

In a case when the one capturing image recording device and each of the plurality of recording image instruction devices all use wired connection and are respectively connected through separate cables, the capturing image recording device includes cable connection terminals corresponding to the number of recording image instruction devices that are connected. Therefore, in such a case, the capturing image recording device is able to separate and receive the image recording instructions from each of the plurality of recording image instruction devices by the respective cable connection terminals thereof.

Further, in a case when the one capturing image recording device and each of the plurality of recording image instruction devices all use wired connection and are connected by one common cable, the environment in which connection is through the one common cable is considered a network (LAN (Local Area Network)) connection. In such a case, network addresses are added to the capturing image recording device and each of the plurality of recording image instruction devices. Furthermore, the communication between the capturing image recording device and each of the recording image instruction devices is performed, for example, by a TDMA (Time Division Multiple Access) method in which communication is performed in a time divisional manner by assigning different communication slots (communication period) to each device.

Further, in a case when the one capturing image recording device and each of the plurality of recording image instruction devices are all wirelessly connected, a plurality of connection channels are assigned to the communication between the capturing image recording device and the plurality of recording image instruction devices. Furthermore, similarly to the TDMA method described above, a method in which transceiving is performed by the capturing image recording device generating the connection channels with the corresponding recording image instruction devices within the communication slots (communication periods) that are different for each recording image instruction device may be used.

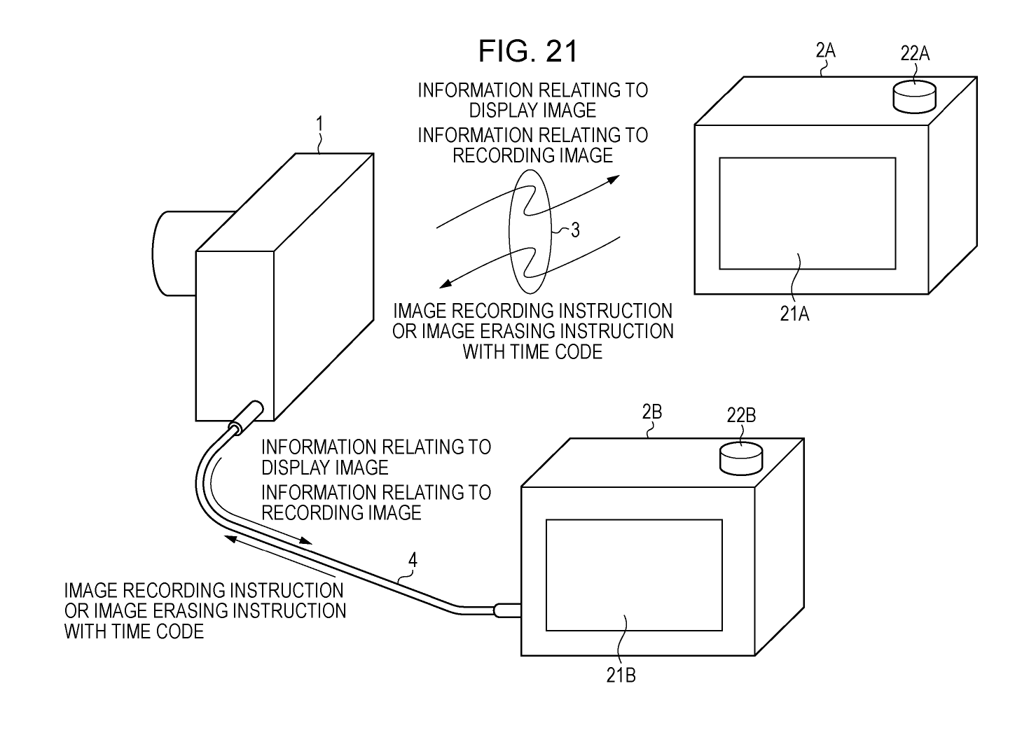

FIG. 21 illustrates a system configuration example of the image recording device according to the fourth embodiment. In the example of FIG. 21, a recording image instruction device 2A is wirelessly connected to one capturing image recording device 1 through the same wireless communication path 3 as an embodiment described above, and a recording image instruction device 2B is connected through a cable 4.

In the example, the capturing image recording device 1 switches the transceiving state with the recording image instruction device 2A through the wireless communication path 3 and the transceiving state with the recording image instruction device 2B through a communication path by the cable 4.

Furthermore, in the recording image instruction device 2A, although the same image recording instruction as the embodiment described above is generated based on an operation of the shutter button 22A by the user, a device identifier is further added to the image recording instruction in the present embodiment. In addition, the recording image instruction device 2A wirelessly transmits the generated image recording instruction to the capturing image recording device 1.

The capturing image recording device 1 receives the image recording instruction, and as described above, compresses and records the recording image signal of a frame that is specified by a recording time code that is included in the image recording instruction in the recording medium 17. Furthermore, at this time, the device identifier of the recording image instruction device 2A is associated with the recording image signal of the frame and recorded.

Further, similarly, in the recording image instruction device 2B, the image recording instruction of the embodiment is generated by further adding a device identifier to the same image recording instruction as that in the embodiment described above based on an operation of the shutter button 22B by the user. Furthermore, the recording image instruction device 2B transmits the generated image recording instruction to the capturing image recording device 1 through the cable 4.

The capturing image recording device 1 receives the image recording instruction, and as described above, compresses and records the recording image signal of a frame that is specified by a recording time code that is included in the image recording instruction in the recording medium 17. Furthermore, at this time, the device identifier of the recording image instruction device 2B is associated with the recording image signal of the frame and recorded.

Furthermore, also in such a fourth embodiment, in the capturing image recording device 1, recording image signals that are stored in the image temporary storage unit become erasable based on the response of an image erasing instruction from the two recording image instruction devices 2A and 2B. However, in the fourth embodiment, the capturing image recording device does not make a recording image signal erasable with an erasing instruction of an image erasing instruction from only one of the two recording image instruction devices 2A and 2B.

That is, a recording image signal of one recording time code is only erasable from the image temporary storage unit 162 when an image erasing instruction is received from both of the two recording image instruction devices 2A and 2B. The reason is that if an image erasing instruction from one recording image instruction device is erased, when an image recording instruction that includes the same recording time code from a different recording image instruction device is later generated, an image is not able to be recorded.

Here, in FIG. 21, a configuration in which the capturing image recording device 1 and the recording image instruction device 2B are configured as an integral capturing device and such an integral capturing device and the recording image instruction device 2A are wirelessly connected as in the example described above is also possible.

Further, although FIG. 21 is a case when two recording image instruction devices are connected to one capturing image recording devices, needless to say, three or more recording image instruction devices may be connectable. In a case when the capturing image recording device is connected to three or more recording image instruction devices, the recording image signal of one recording time code only becomes erasable from the image temporary storage unit 162 when image erasing instructions are received from all of the three or more recording image instruction devices.

### 16. Image Recording Device (Fifth Embodiment)

In the embodiments described above, it has been described that the frame rates of recording image signals to be recorded are fixed. However, it is also possible for the user of the recording image instruction device to be able to change the setting of the frame rate.

The case of the first embodiment will be described as an example. If a predetermined button operation is performed on the recording image instruction device 2, the recording image instruction device 2 enters a recording frame rate setting mode and receives setting of the recording frame rate from the user. Furthermore, the recording image instruction device 2 transmits information of the received recording frame rate to the capturing image recording device 1.

In the capturing image recording device, the clock signal Fck that is synchronized with the frame rate from the timing signal generation unit 18 is configured to be changeable according to the information of the recording frame rate from the recording image instruction device. Therefore, when the capturing image recording device 1 receives the information of the recording frame rate, the capturing image recording device 1 controls the frequency of the clock signal Fck from the timing signal generation unit 18 so that the clock signal Fck becomes a frame rate that corresponds to the received information of the recording frame rate. The frame rate (recording frame rate) of the recording image signal that is stored in the image temporary storage unit is thereby changed.

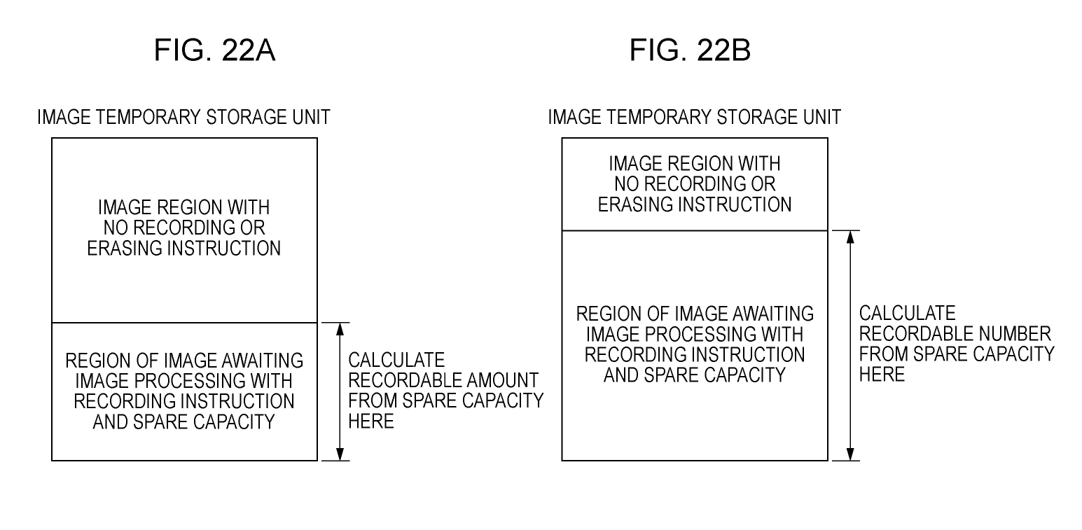

Here, in a case when the recording frame rate is high, as illustrated in FIG. 22A, the number of frames of recording image signals that are stored in the image temporary storage unit 162 increases and the storage region in which images for which a recording instruction or an erasing instruction has not yet arrived are recorded increases. Therefore, the number of frames that are detected as the number of savable frames decreases.

On the other hand, in a case when the recording frame rate is low, as illustrated in FIG. 22B, some room is generated between the arriving timing of a frame of a recording image signal that is stored in the image temporary storage unit 162 and the arrival timing of a recording instruction or an erasing instruction. The frame is thereby made to be erasable and erased according to the recording instruction or the erasing instruction, and a region that becomes free space increases. Therefore, the number of frames that are detected as the number of savable frames increases.

Since the erasable region and empty space in the image temporary storage unit 162 in the capturing image recording device 1 changes in such a manner according to the change in setting of the frame rate by the user, the number of savable frames changes. Therefore, if the number of savable frames is displayed on the display 21 of the recording image instruction device 2, the number of savable frames that are displayed changes.

Further, since the frame of a display image that is sent from the capturing image recording device 1 to the recording image instruction device 2 is also changed, in the recording image instruction device 2, the manner of the change in the display image on the display 21 changes according to changes in the setting of the frame rate.

The user is therefore able to set the desired recording frame rate while verifying changes in the display image on the display 21 and changes in the number of savable frames.

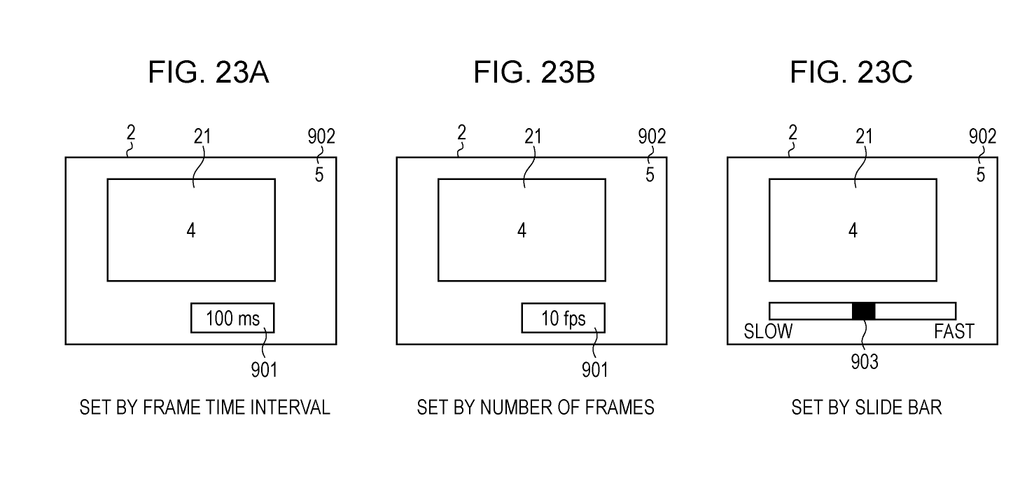

FIGS. 23A to 23C are diagrams that illustrate some examples of setting input methods of the recording frame rate by the user in the recording image instruction device 2.

FIG. 23A is a case when the recording frame rate is set by a frame time interval. In such a case, the set frame time interval is time displayed on a frame rate display unit 901. A display 902 of the number of savable frames changes according to the set frame time interval.

FIG. 23B is a case when the recording frame rate is set by the number of frames. In such a case, the numerical value of the set frame rate fps (frames per second) is displayed on the frame rate display unit 901.

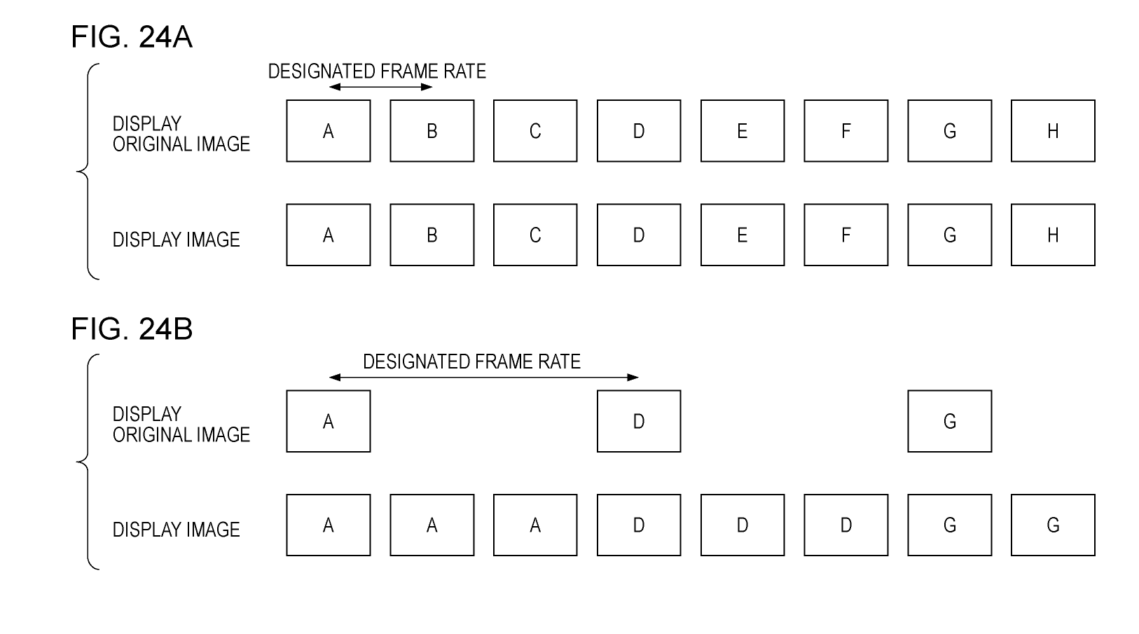

Further, FIG. 23C is a case when the recording frame rate is set by a slide bar 903. In such a case, according to the setting position of the slide bar 903, as illustrated in FIGS. 24A and 24B, for example, the manner of the change of the display image on the display 21 changes and the display 902 of the number of savable frames further changes.

### 17. Image Recording Device (Sixth Embodiment)

Although a case when a capturing image of a still image is recorded has mainly been described in the embodiments described above, embodiments of the disclosure are able to be applied to a case when a capturing image of a moving image is recorded. In a case when recording a capturing image of a moving image, the recording image instruction of the case of the still image as described above is used for the recording start of the moving image or the recording end of the moving image.

That is, in FIG. 1, for example, when the user operates to start moving image recording by the recording image instruction device 2 while watching the monitor display image that is displayed on the display 21 of the recording image instruction device 2, the recording start instruction that includes the recording time code of the image frame that was being displayed on the monitor at the time of the operation is sent from the recording image instruction device 2 to the capturing image recording device 1 and moving image recording is started by the capturing image recording device 1.

Furthermore, when the user operates to stop moving image recording by the recording image instruction device 2 while watching the monitor display screen that is displayed on the display 21, the recording end instruction that includes the recording time code of the image frame that was being displayed on the monitor at the time of the operation is sent from the recording image instruction device 2 to the capturing image recording device 1 and the moving image recording is ended.

In so doing, it is possible to start moving image recording from the image frame intended by the user, and to stop moving image recording at the image frame intended by the user. In the case of moving image recording, the recording image signals of the moving image are read and recorded from a frame region in which the recording image signal of a frame that is specified by a recording time code that is included in the recording image instruction out of a plurality of frame regions of the image temporary storage unit 162.

### 18. Image Recording Device (Seventh Embodiment)

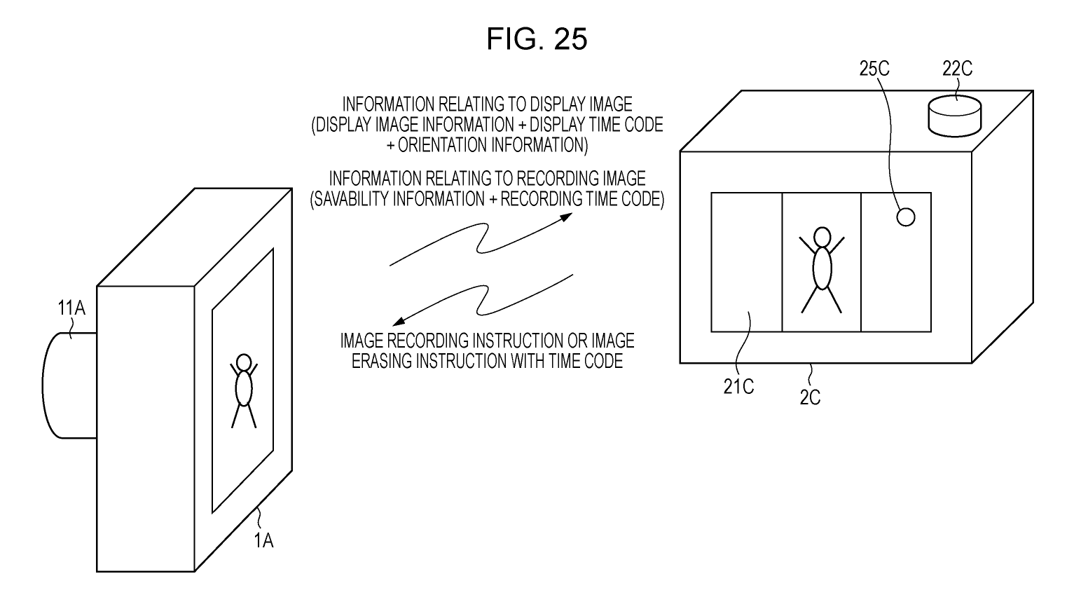

Next, an image storage device according to a seventh embodiment of the disclosure will be described. FIG. 25 is a system configuration diagram of an embodiment of the image recording device of the present embodiment that is applied in a case when recording a capturing image of a still image. Since the only differences from the first embodiment described above are that the image recording device of the embodiment includes a function of the capturing image recording device 1A generating the orientation information of itself and a function of transmitting the generated orientation information to a recording image instruction device 2C through the wireless communication path 3 and includes a function of the recording image instruction device 2C generating orientation information of itself, description of duplicate configurations and operations is omitted, and description of configurations and operations that are different will be made below.

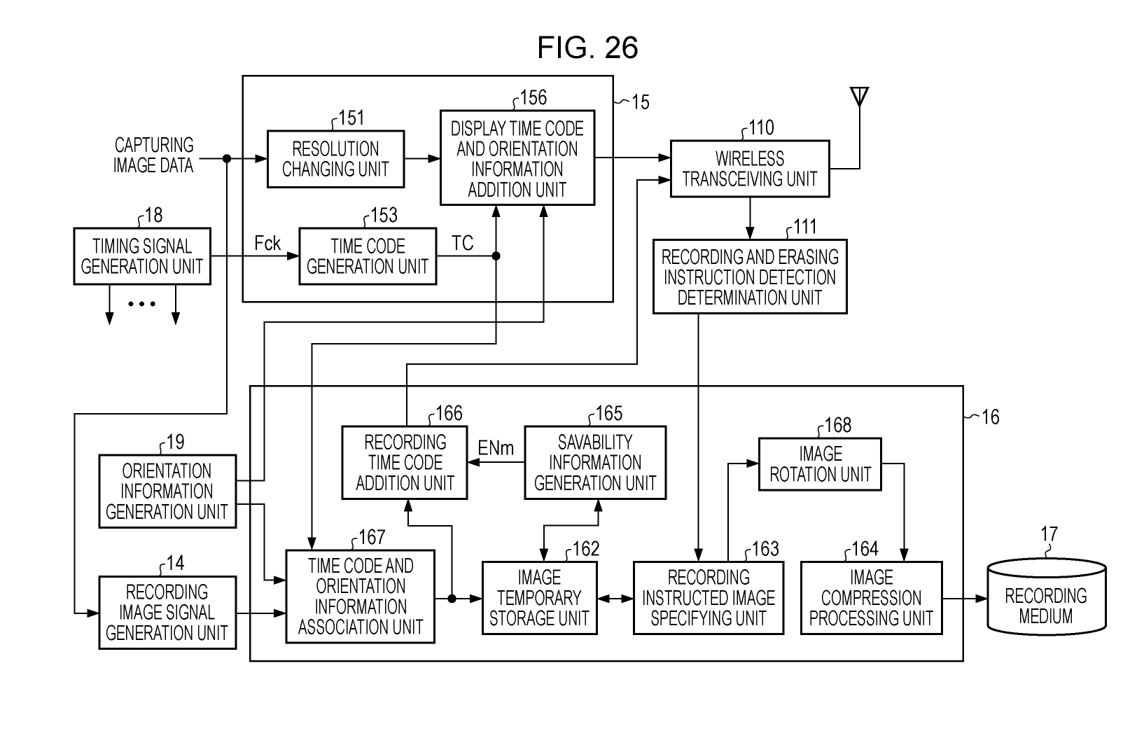

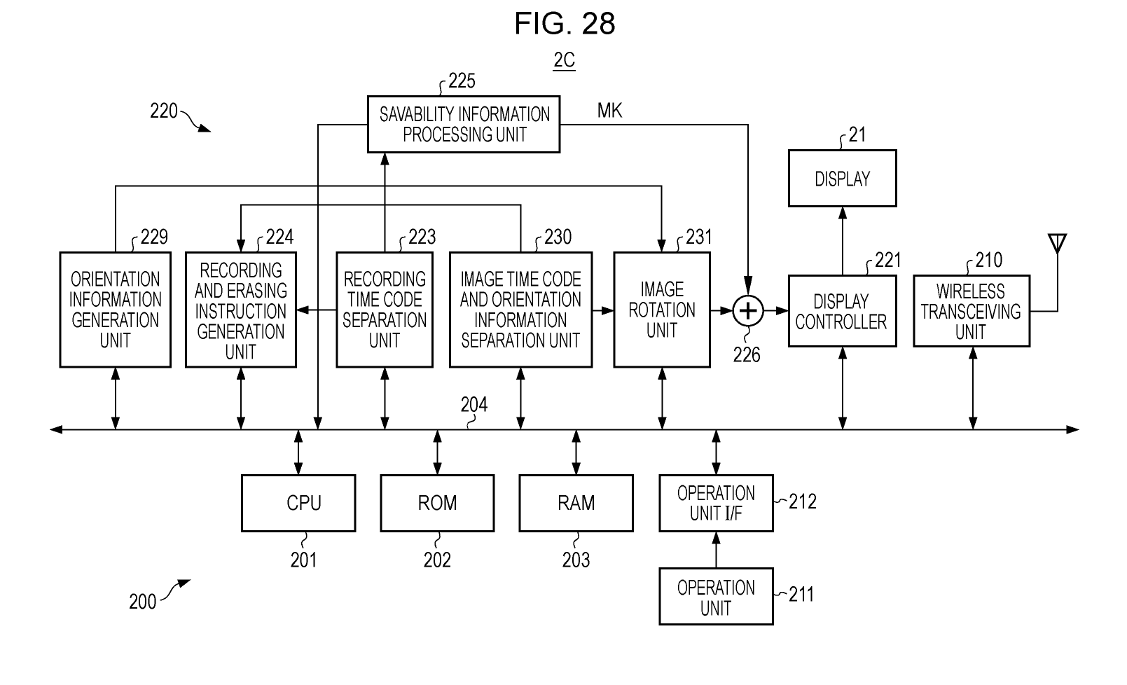

The capturing image recording device 1A includes, as illustrated in FIG. 26 described later, an orientation information generation unit 19 that generates orientation information of itself. Further, as illustrated in FIG. 28 described later, the recording image instruction device 2C includes an orientation information generation unit 229 that generates orientation information of itself.

### 19. Configuration Example of Display Image Generation Unit and Instructed Image Recording Unit (Seventh Embodiment)

Next, with regard to FIG. 26, detailed configuration examples of the display image signal generation unit 15 and the instructed image recording unit 16 in the capturing image recording device 1A of the present embodiment will be described. FIG. 26 illustrates the functions of the configurations of the display image signal generation unit 15 and the instructed image recording unit 16 of the capturing image recording device 1A as blocks.

As illustrated in FIG. 26, the display image signal generation unit 15 includes the resolution changing unit 151, a display time code and orientation information adding unit 156, and the time code generation unit 153. The resolution changing unit 151 generates display image data with a resolution that is based on control information of the display resolution from the control unit 100 with the capturing image data from the capturing signal generation unit 13, and supplies the generated display image data to the display time code and orientation information adding unit 156.

The display time code and orientation information adding unit 156 adds the time code TC (display time code) and orientation information from the orientation information generation unit 19 to frame units of the display image from the resolution changing unit 151. Furthermore, the display time code and orientation information adding unit 156 wirelessly transmits the display image data to which the display time code and the orientation information are added to the recording image instruction device 2 through the wireless transceiving unit 110. The information relating to the display image corresponds to the display image to which the display time code and the orientation information are added which is output from the display image signal generation unit 15.

The instructed image recording unit 16 is configured to include a time code and orientation information association unit 167, the image temporary storage unit 162, the recording instructed image specifying unit 163, the image compression processing unit 164, the savability information generation unit 165, the recording time code adding unit 166, and an image rotation unit 168.

In addition to recording image signals from the recording image signal generation unit 14 being supplied to the time code and orientation information association unit 167, the time code TC from the time code generation unit 153 of the display image signal generation unit 15 and the orientation information from the orientation information generation unit 19 are supplied.

The time code and orientation information association unit 167 adds the time code TC (recording time code) and the orientation information to frame units of the recording image signals (each of the recordable images) from the recording image signal generation unit 14 and supplies the time code TC and the orientation information to the image temporary storage unit 162. Further, the time code and orientation information association unit 167 supplies recording time codes that are added to recording image signals to the recording time code adding unit 166.

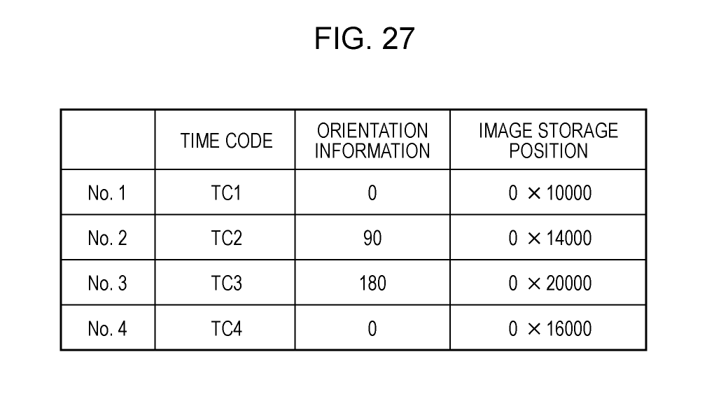

In the example, the image temporary storage unit 162 is configured, as described above, to store recording image signals of four frames along with the recording time codes thereof. The storage content of the image temporary storage unit 162 will be described with reference to FIG. 27.

That is, the image temporary storage unit 162 includes four frame storage regions of No. 1 to No. 4, and is able to store recording image signals of four frames in frame units in a state in which the recording time code and the orientation information are associated in the four frame storage regions.

Furthermore, as described below, the recording instructed image specifying unit 163 receives a determination result of whether the response from the recording and erasing instruction detection determination unit 111 is an image recording instruction or an image erasing instruction and performs recording or erasing processing of an image that is temporarily stored in the image temporary storage unit 162.

First, when the recording instructed image specifying unit 163 receives a determination result that the response from the recording and erasing detection determination unit 111 is an image recording instruction, the recording instructed image specifying unit 163 specifies the image of a frame for which there is an instruction for image recording by the recording time code that is sent at the same time. That is, the recording instructed image specifying unit 163 specifies the frame of a recording image signal that includes the same recording time code as the recording time code that is received from the recording and erasing instruction detection determination unit 111 as the recording image signal of the frame to be recorded.

Furthermore, the recording instructed image specifying unit 163 searches for and reads the frame of the specified recording image signal based on the recording time code from among the recording image signals that are stored in the image temporary storage unit 162 and supplies the frame to the image rotation unit 168 along with the orientation information.

The image rotation unit 168 performs image rotation processing on the supplied recording image signal based on the supplied orientation information, and supplies the recording image signal that has been image rotation processed to the image compression processing unit 164.

The image compression processing unit 164 compression processes a recording image signal by an appropriate still image compression processing method such as, for example, a JPEG (Joint Photographic Experts Group) method, and records the compressed image signal in the recording medium 17. Further, the image compression processing unit 164 may associate the compressed image signal with the orientation information to record in the recording medium 17. In such a case, there is no cause to perform image rotation processing on the recording image signal.

### 20. Configuration Example of Recording Image Instruction Device (Seventh Embodiment)

Next, a block diagram of a configuration example of the recording image instruction device 2C is illustrated in FIG. 28. The recording image instruction device 2C of the example is configured to include the control unit 200, the wireless transceiving unit 210, the operation unit 211 that includes a shutter button, and the display and recording and erasing instruction generation unit 220.

The display and recording and erasing instruction generation unit 220 is composed of the display 21, the display controller 221, the display time code and orientation information separation unit 230, the recording time code separation unit 223, the recording and erasing instruction generation unit 224, the savability information processing unit 225, the savability display addition unit 226, the orientation information generation unit 229, and an image rotation unit 231. Here, the display time code and orientation information separation unit 230, the recording time code separation unit 223, the recording and erasing instruction generation unit 224, the savability information processing unit 225, the savability display addition unit 226, the orientation information generation unit 229, and the image rotation unit 231 may be configured as software processes by a microcomputer that configures the control unit 200.

The display time code and orientation information separation unit 230 receives the information relating to the display image that is received by the wireless transceiving unit 210 from the capturing image recording device 1 through the system bus 204, and separates the display time code and the orientation information from the information relating to the display image. Furthermore, the display time code and orientation information separation unit 230 supplies the display time code to the system bus 204 and the recording and erasing instruction generation unit 224, supplies the orientation information to the system bus 204 and the image rotation unit 231, and supplies the display image signal to the image rotation unit 231.

The image rotation unit 231 performs image rotation processing on the supplied display image signal based on the orientation information that is supplied from the display time code and orientation information separation unit 230 and the orientation information supplied from the orientation information generation unit 229, and supplies the display image signal that has been image rotation processed to the savability display addition unit 226.

Furthermore, the savability information addition unit 226 adds the display image signal to the savability display information and supplies the display image signal of the addition result to the display controller 221. The display controller 221 displays an image by the display image signal to which the savability display information is added as a monitor display image when capturing on the screen of the display 21.

According to the embodiment, it is possible to display the monitor display image facing the correct way even in a case when either of the orientation of the capturing image recording device 1A or the recording image instruction device 2C changes.

### 21. Other Embodiments and Modified Examples

Although the savability information is displayed by superimposing a display image on the display in the embodiments described above, the savability information may be displayed on the display by separating the display region from the display image. In such a case, it is preferable that the display image and the savability that have a corresponding relationship be displayed at the same time so that correspondence with the arriving display image to which the savability information is added is possible.

Further, the savability information may be displayed by different display elements as the display of the display image. However, even in such a case, the display timing of the display image and the display timing of the savability information are the same so correspondence with the arriving display image to which the savability information is added is possible.

Further, although the capturing image recording device 1 and the recording image instruction device 2 have been connected by a wireless connection path in the embodiments described above, the connection may be a wired connection by a cable.

Further, the capturing image recording device 1 and the recording image instruction device 2 may be configured to be connected through a network such as a LAN (Local Area Network).

Further, although the portion of the capturing image recording device 1 and the portion of the recording image instruction device 2 have been separate in the embodiments described above, in a case when there is a delay in the exchanges of signals between the portion of the capturing image recording device 1 and the portion of the recording image instruction device 2, the embodiment of the disclosure are able to be applied even if the portion of the capturing image recording device 1 and the portion of the recording image instruction device 2 are integrated.

Further, as described above, the processing operations of the first to seventh embodiments described above are configured to be executed by software processing using a microcomputer.

Further, although a still image that is capturing recorded has been composed of one frame in the embodiments described above, a still image of which the resolution is improved may be recorded as a still image to be capturing recorded by stacking a plurality of image frames that are temporally consecutive.

Further, although the embodiments described above are a case when a capturing image signal from a capturing element is recorded as a still image or a moving image, the image signal to be recorded is not limited to capturing image signals.

Further, the embodiments of the disclosure may be realized by supplying a recording medium on which a program code of software that realizes the functions of each of the embodiments described above to a system or a device, and reading and executing the program code that a computer (or a CPU, an MPU, or the like) of the system or the device stores in the recording medium.

In such a case, the program code itself that is read from the recording medium realizes the functions of each of the embodiments described above, and the program code and the recording medium that stores the program code configure the embodiments of the disclosure.

Further, as a storage medium for supplying the program code, for example, a floppy (registered trademark) disk, a hard disk, a magneto-optical disc, an optical disc such as a CD-ROM, a CD-R, a CD-RW, a DVD-ROM, a DVD-RAM, a DVD-RW, or a DVD+RW, a magnetic tape, a non-volatile memory card, or a ROM may be used. Further, the program code may be downloaded via a network.

Further, by executing the program code that the computer reads, not only are the functions of each of the embodiments described above realized, but a case when an OS (Operating System) or the like that is operational on the computer performs a part or all of the actual processes based on the instructions of the program code and the functions of each of the embodiments described above are realized by such processing is included.

Furthermore, a case when, after the program code that is read from the storage medium is written into a memory that is included in a function enhancement board that is inserted in the computer or a function enhancement unit that is connected to the computer, a CPU or the like in which the enhancement function is included in the enhancement board or the enhancement unit performs a part or all of the actual processes based on the instructions of the program code and the functions of each of the embodiments described above are realized by such processing is included.

Although the preferable embodiments of the disclosure have been described in detail above with reference to the attached drawings, the embodiments of the disclosure are not limited to such examples. It is clear that those with ordinary knowledge of the field of technology of the disclosure may conceive of various modified examples and amendment examples within the scope of the technical idea of the range of the claims, and it is understood that such modification examples and amendment examples are naturally also within the technical scope of the disclosure.

What is claimed is:

1. An image recording device comprising:
an image recording unit; and a recording image instruction unit,
the image recording unit including
a first time code adding unit that adds a time code to each frame of a display image that is input at a first frame rate,
an image temporary storage unit that associates a plurality of frames of a recordable image which are input at a second frame rate with a time code and temporarily stores the plurality of frames in an unused region or an erasable region,
a savability information generation unit that generates savability information of the recordable image in the image temporary storage unit,
a second time code adding unit that adds a time code that is associated with the recordable image to the savability information,
a first transmission unit that transmits the display image, to which a time code is added, to the recording image instruction unit at the first frame rate and transmits the savability information to the recording image instruction unit,
a determination unit that determines whether or not a response with a time code from the recording image instruction unit is an image recording instruction, and
a recording execution unit that obtains an image of a frame, which is specified based on the time code that is included in the response, from the image temporary storage unit when it is determined by the determination unit that the response is the image recording instruction and that records the image in a recording medium, and
the recording image instruction unit including
an image display unit that displays on a display the display image from the image recording unit to which the time code has been added,
an operation unit that receives an operation input,
a monitoring unit that monitors an operation input through the operation unit regarding the display image that is displayed on the display,
a response generation unit that generates as the response an image recording instruction that includes the time code that has been associated with the recordable image from the image recording unit based on each time code of the display image when it is determined by the monitoring unit that an operation through the operation unit is performed, and
a second transmission unit that transmits the response that is generated by the response generation unit to the image recording unit.

2. The image recording device according to claim 1,
wherein the response generation unit generates as the response an erasable instruction that includes the time code that has been associated with the recordable image based on each time code of the display image when it is determined that there is no operation through the operation unit by the user, and
wherein the image recording unit includes an erasing processing unit that makes a storage region of the image temporary storage unit for an image of a frame that is specified by a time code that is included in the response erasable, when it is determined by the determination unit that the response is not the image recording instruction.

3. The image recording device according to claim 1,
wherein the recording image instruction unit includes a savability display unit that displays savability based on the savability information from the image recording unit in a state of the savability being associated with the display image.

4. The image recording device according to claim 3,
wherein the savability information generation unit generates as the savability information the number of image savable frames in the image temporary storage unit.

5. The image recording device according to claim 1,
wherein the recording image instruction unit includes a determination unit that determines whether or not an image of a frame that is specified by the operation input has been stored in the image temporary storage unit of the image recording unit based on the savability information from the image recording unit when there is an operation input by the user through the operation unit, and
a warning unit that causes at least one of a warning display and a warning sound to be made in response to the operation input when it is determined by the determination unit that an image of a frame that is specified by the operation input has not been stored in the image temporary storage unit of the image recording unit.

6. The image recording device according to claim 1,
wherein the image recording unit includes a frame rate setting unit that sets the second frame rate of the recordable image in response to an instruction by the user to change the second frame rate.

7. The image recording device according to claim 1,
wherein the recording image instruction unit includes a receiving unit that receives a deletion instruction relating to an image for which there is an instruction for the image recording through the operation unit, and
a third transmission unit that adds a time code of the image, for which there is an instruction for deletion, to the deletion instruction that is received by the receiving unit and transmits the deletion instruction to the image recording unit, and
wherein the image recording unit includes an image deletion unit that receives the deletion instruction from the recording image instruction unit and deletes an image that is specified by the time code that is included in the deletion instruction from images in the image temporary storage unit, the recording medium, or that is being recorded.

8. The image recording device according to claim 1, wherein the image recording unit and the recording image instruction unit are separate from each other.

9. The image recording device according to claim 8, wherein two or more recording image instruction units are connectable to one image recording unit.

10. The image recording device according to claim 1,
wherein the image recording unit includes a first frame interpolation unit that performs frame interpolation with respect to a display image that is input at a third frame rate and supplies the display image to the first time code adding unit at the first frame rate.

11. The image recording device according to claim 1,
wherein the recording image instruction unit includes a second frame interpolation unit that performs frame interpolation with respect to the display image that is received from the image recording unit at the first frame rate and supplies the display image to the image display unit at a fourth frame rate, and
wherein the second frame interpolation unit also performs interpolation with respect to a time code of the display image that is received at the first frame rate.

12. The image recording device according to claim 1,
wherein the image recording unit includes a first buffer unit that performs buffering of a display image that is input at a fifth frame rate and supplies the display image to the first time code adding unit at the first frame rate.

13. The image recording device according to claim 1,
wherein the recording image instruction unit includes a second buffer unit that performs buffering of the display image that is received from the image recording unit at the first frame rate and supplies the display image to the image display unit at a sixth frame rate.

14. The image recording device according to claim 1,
wherein the image recording unit includes a first orientation information generation unit that generates orientation information of the image recording unit,
wherein the first time code adding unit further adds orientation information that is generated by the first orientation information generation unit to each frame of a display image that is input at the first frame rate,
wherein the first transmission unit transmits the display image to which orientation information that is generated by the first orientation information generation unit is further added to the recording image instruction unit,
wherein the recording image instruction unit includes a second orientation information generation unit that generates orientation information of the recording image instruction unit, and
wherein the image display unit displays the display image from the image recording unit, to which the orientation information that is generated by the first orientation information generation unit is further added, on the display based on the orientation information that is generated by the first orientation information generation unit and based on the orientation information generated by the second orientation information generation unit.

15. The image recording device according to claim 14,
wherein the image temporary storage unit further associates a plurality of frames of the recordable image with orientation information that is generated by the first orientation information generation unit and temporarily stores the frames associated with the orientation information.

16. The image recording device according to claim 15,
wherein the recording execution unit further obtains orientation information that is generated by the first orientation information generation unit from the image temporary storage unit, associates an image with the orientation information that is generated by the first orientation information generation unit, and records the image associated with the orientation information on the recording medium.

17. An image recording method, comprising:
causing an image recording unit to
add a time code to each frame of a display image that is input at a first frame rate,
associate a plurality of frames of a recordable image which are input at a second frame rate with a time code and store the plurality of frames in an image temporary storage unit that temporarily stores the frames in an unused region or an erasable region,
generate savability information of the recordable image in the image temporary storage unit,
add a time code that is associated with the recordable image to the savability information,
transmit the display image, to which a time code is added, to a recording image instruction unit at the first frame rate and transmit the savability information to the recording image instruction unit,
determine whether or not a response with a time code from the recording image instruction unit is an image recording instruction, and
obtain an image of a frame, which is specified based on the time code that is included in the response, from the image temporary storage unit when it is determined that the response is the image recording instruction and record the image in a recording medium; and
causing the recording image instruction unit to
display on a display the display image from the image recording unit, to which the time code has been added,
monitor an operation input through an operation unit regarding the display image that is displayed on the display,
generate as the response an image recording instruction that includes the time code that has been associated with the recordable image from the image recording unit based on each time code of the display image when it is determined that an operation through the operation unit is performed, and
transmit the generated response to the image recording unit.

18. A program to cause a computer to function as
an image recording unit including
a first time code adding unit that adds a time code to each frame of a display image that is input at a first frame rate,
an image temporary storage unit that associates a plurality of frames of a recordable image which are input at a second frame rate with a time code and temporarily stores the plurality of frames in an unused region or an erasable region,
a savability information generation unit that generates savability information of the recordable image in the image temporary storage unit,
a second time code adding unit that adds a time code that is associated with the recordable image to the savability information,
a first transmission unit that transmits the display image, to which a time code is added, to a recording image instruction unit at the first frame rate and transmits the savability information to the recording image instruction unit,
a determination unit that determines whether or not a response with a time code from the recording image instruction unit is an image recording instruction, and
a recording execution unit that obtains an image of a frame, which is specified based on the time code that is included in the response, from the image temporary storage unit when it is determined by the determination unit that the response is the image recording instruction and that records the image in a recording medium, and function as
the recording image instruction unit including
an image display unit that displays on a display the display image from the image recording unit to which the time code has been added,
an operation unit that receives an operation input,
a monitoring unit that monitors an operation input through the operation unit regarding the display image that is displayed on the display,
a response generation unit that generates as the response an image recording instruction that includes the time code that has been associated with the recordable image from the image recording unit based on each time code of the display image when it is determined by the monitoring unit that an operation through the operation unit is performed, and
a second transmission unit that transmits the response that is generated by the response generation unit to the image recording unit.
